(19) United States
(12) Patent Application Publication
(10) Pub. No.: US 2026/0250022 A1
(43) Pub. Date: Aug. 27, 2026

(54) MOVING PLATFORM FOR TRANSPORTING THINGS

(71) Applicant: SKYWORKER TECHNOLOGIES LTD., Gedera (IL)

(72) Inventor: Shlomo VOROVITCHIK, Kidron (IL)

(21) Appl. No.: 18/993,702

(22) PCT Filed: Jul. 18, 2023
(86) PCT No.: PCT/IL2023/050748

§ 371 Date: Jan. 13, 2025

Related U.S. Application Data
(60) Provisional application No. 63/368,719, filed on Jul. 18, 2022.

(51) Int. Cl. B64U 50/20; B64U 10/13; B64U 30/26; B64U 40/10

(52) U.S. Cl. CPC B64U 50/20; B64U 10/13; B64U 30/26; B64U 40/10

(57) ABSTRACT

Some embodiments relate to a thrusting assembly for mounting on an aerial platform and configured for generating thrusting power to allow a controllable accelerated air mass flow in and out the thrusting assembly. The thrusting assembly includes one or more fluid-based rotary actuators, or motors, in fluid communication with a source of energized/pressurized working fluid for receiving energized working fluid to thereby driving the one or more fluid-based rotary actuators. The thrusting assembly further includes one or more actuator disc arrangements, each comprising a plurality of blades, rotatable by said one or more fluid-based rotary actuators. A valving mechanism of the thrusting assembly is disposed along a flow path between the source of energized working fluid and the one or more fluid-based rotary actuators.

### CROSS-REFERENCE TO RELATED APPLICATIONS

This application is a national phase filing under 35 C.F.R. § 371 of and claims priority to PCT Patent Application No. PCT/IL2023/050748, filed on Jul. 18, 2023, which claims the priority benefit under 35 U.S.C. § 119 of U.S. Provisional Patent Application No. 63/368,719, filed on Jul. 18, 2022, the content of which is hereby incorporated in its entirety by reference.

### TECHNOLOGICAL FIELD

The present disclosure is in the field of moving platforms for transforming things, in particular useful in autonomous robotic applications.

### GENERAL DESCRIPTION

A moving platform, vehicle, robot and/or any other device with a structure, piece of mechanized equipment for transporting payload, persons or thing has a mission which constrained by its power and energy densities. It has long been a goal of autonomous robotic or moving platforms to operate fast, accurate and cheaply. A high-power density hardware is needed as autonomous robotic applications and robotics missions are advancing. The apparatus and methods described here allows autonomous applications to accelerate faster and accurately in all 6 Degrees of Freedom (DOF) in space. Similar, high energy density hardware, energy storage, batteries and/or fuel containers allow autonomous moving platform to operate for longer period and complete their mission faster and precisely.

Today, the selection of the energy storage, motor(s) and/or engine(s) on a moving platform is a design process done according to the moving platform application and according to the moving platform mission. Hence, in most cases the moving platform subsystems, such as powertrain, drivetrain, transmission and powerplants determine the total power density and energy density of a moving platform.

The present disclosure presents here an apparatus, a moving platform and methods that include a fluid drive subsystem, part of the powertrain, drivetrain and transmission subsystem connected to a powerplant unit. Together, the fluid drive subsystem and the powerplant unit provide a new breed of moving platform, with improved power density and energy densities that are most suitable to an autonomous robotic moving platform.

In addition, Ariel and Aerospace moving platforms for example, such as Vertical Take-Off and Landing (VTOL) vehicles, may benefit from the technique of the present disclosure allowing additional physical and aerodynamics capabilities such as unique Disc Loading vs moving platform weight, low Polar moment of Inertia of the thrusting system, fixable and sized changing powertrain, flexible and adaptable structure of the moving platform. And partially airborne moving platform combined with different power source and/or powerplant. This allows high-specific power and specific energy for different class, sized, shape of an aerodynamic vehicles concepts of VTOL moving platforms.

Therefore, an aspect of the present disclosure provides a thrusting assembly for mounting on an aerial platform and configured for generating thrusting power to allow a controllable accelerated air mass flow in and out the thrusting assembly. The thrusting assembly comprises one or more fluid-based rotary actuators, or motors, in fluid communication with a source of energized/pressurized working fluid for receiving energized working fluid to thereby driving the one or more fluid-based rotary actuators. The thrusting assembly further comprises one or more actuator disc arrangements, each comprising a plurality of blades, rotatable by said one or more fluid-based rotary actuators. A valving mechanism of the thrusting assembly is disposed along a flow path between the source of energized working fluid and the one or more fluid-based rotary actuators. The thrusting assembly further comprises at least one processing circuitry; one or more memories coupled to the at least one processing circuitry and storing programming instructions for execution by the at least one processing circuitry to: (1) control said valving mechanism to result in at least one of: (i) selected flow rate, (ii) selected fluid pressure, and (iii) selected temperature of said energized working fluid in said one or more fluid-based rotary actuators or being received in said one or more fluid-based rotary actuators. This configuration of the thrusting assembly enables controlling of the instant angular acceleration and the rotational speed of the motor and therefore the rotational motion of the actuator disc arrangements.

In some embodiments of the thrusting assembly, the plurality of blades are coupled to the respective rotor by a hinge. An angle of attack of the plurality of blades is defined by forces acting on the hinge. Namely, the hinge is a passive hinge and the blade is pivotable about the hinge in response to the forces acting on the hinge, such as the instant torque and centrifugal forces.

In some embodiments of the thrusting assembly, the processing circuitry is configured to control said valving mechanism to result in a selected rotational profile of said one or more actuator disc arrangements. Said selected rotational profile comprises a varying angular acceleration in a single rotation or in a selected number of rotations while maintaining a selected RPM (revolution per minute) in said single rotation, namely, in part of the rotation, the blades are accelerating and in part of the rotation, the blade are decelerating such that the total time of the single rotation is according to the given and desired RPM, or in said selected number of rotations, namely, in part of the rotation within said selected number of rotations the blades are accelerating and in part of the rotation, the blade are decelerating such that the total time of the selected number of rotations is according to the given and desired RPM.

In some embodiments of the thrusting assembly, said processing circuitry is configured to control said source of energized working fluid, directly or indirectly, to affect the fluid pressure being output therefrom towards the fluid-based rotary actuators.

In some embodiments of the thrusting assembly, said energized working fluid is liquid, i.e. hydraulic liquids, and said one or more fluid-based rotary actuators is/are hydraulic motor(s).

In some embodiments of the thrusting assembly, said liquid flows in a closed-loop flow with one or more low and high pressure loops.

In some embodiments of the thrusting assembly, said energized working fluid is gas and said one or more fluid-based rotary actuators is/are pneumatic motor(s) and/or heat-pump rotary expander(s).

In some embodiments of the thrusting assembly, said gas is air and said one or more fluid-based rotary actuators operate based on an open-loop flow of said gas. Namely, air that participated in the operation of the motor is released back to the surroundings and new air is suctioned to the motor to be compressed.

In some embodiments of the thrusting assembly, each of said one or more actuator disc arrangements comprises a rotor shaft coupled to said one or more fluid-based rotary actuators for allowing rotation of the respective fluid-based rotary actuator. The thrusting assembly further comprises a rotor shaft angular position sensor configured for sensing the angular position of the rotor shaft and generate rotor angular position data based thereon. Said processing circuitry is configured to allow controlling of the rotor shaft rotation profile, and therefore the fluid-based rotary actuator rotation profile, based on the fluid-based rotary actuator angular position data and to selectively control the rotation velocity at each angular position according to a desired rotation profile.

In some embodiments of the thrusting assembly, said processing circuitry is configured to control the rotational acceleration of said blades and the angle of attack of each blade.

In some embodiments of the thrusting assembly, the processing circuitry is configured to control the angle of attack of each blade independently based upon the time domain and/or based upon the instant angular position of the actuator disc.

In some embodiments, the thrusting assembly further comprises a tilt sensor for sensing the tilt of the aerial platform (vehicle) carrying the thrusting assembly and generate tilt data based thereon, wherein said processing circuitry is configured to control said valving mechanism based on said tilt data.

In some embodiments of the thrusting assembly, said processing circuitry is configured to control said valving mechanism by a pulse-width modulation technique. Namely, the electronics operating the valves receive pulses in a rate that is faster than it takes the load to change significantly.

In some embodiments of the thrusting assembly, said processing circuitry is configured to control the valving mechanism to allow a controlled maneuvering of the aerial platform (vehicle) carrying the thrusting assembly in at least six degrees of freedom.

In some embodiments of the thrusting assembly, said source of energized fluid comprises at least two sub-sources of energized working fluid, each being configured to provide an energized working fluid in a different pressure to allow feed of the one or more fluid-based rotary actuators with a range of pressures of the fluid.

In some embodiments of the thrusting assembly, said source of energized working fluid comprises one or more liquid pumps.

In some embodiments of the thrusting assembly, said source of energized working fluid comprises one or more compressors.

In some embodiments, the thrusting assembly further comprises a cooling arrangement in fluid communication with said source of energized working fluid for cooling the energized working fluid.

In some embodiments, the thrusting assembly further comprises a power source for powering said source of energized working fluid. The power source can be a battery or a generator based on consumption of non-renewable materials, such as fuels.

In some embodiments, the thrusting assembly further comprises said source of energized working fluid. It is to be noted that energized fluid refers to fluid characterized by any pressure above ambient pressure and/or chemically reactive.

In some embodiments of the thrusting assembly, said processing circuitry is configured to control said valving mechanism to control the angular position, velocity and acceleration of the one or more fluid-based rotary actuators, or at least a shaft rotatable by the one or more fluid-based rotary actuators, to thereby control mechanical motion of the one or more actuator disc arrangements, which in turn generates thrusting powers and acceleration of air mass flow across the thrusting assembly.

In some embodiments of the thrusting assembly, each of said one or more fluid-based rotary actuators comprises a rotatable motor shaft coupled to a respective actuator disc arrangement of said one or more actuator disc arrangements for allowing rotation of the respective rotor. The thrusting assembly further comprises a motor shaft angular position sensor configured for sensing the angular position of the motor shaft and generating motor angular position data based thereon. The processing circuitry is configured to allow controlling of the motor shaft rotation profile, and therefore the motor and the rotor rotation profile, based on the motor angular position data and to selectively control the rotation velocity at each angular position according to a desired rotation profile.

In some embodiments of the thrusting assembly, said one or more fluid-based rotary actuators is/are operable to result in air mass flow through the thrusting assembly in two opposite directions. Namely, air may flow from the top of the thrusting assembly downwards and from the bottom of the thrusting assembly upwards. In other words, the air mass flow can change direction within the thruster assembly as some mass air flow may enter the thruster inlet and in some cases the mass air may exit via the thruster inlet.

In some embodiments of the thrusting assembly, said processing circuitry is configured to control said valving mechanism to controllably result said air mass flow through the thrusting assembly in two opposite directions according to desired maneuver of the aerial platform.

In some embodiments, the thrusting assembly further comprises a combustion component configured to heat air mass flow that flows from the one or more actuator disc arrangements to thereby further accelerate the air mass flow. The combustion component allows to obtain a hypersonic flow of the air mass flow through the thrusting assembly. The combustion component is arranged downstream the actuator disc arrangements with respect to the air flow path through the thrusting assembly.

In some embodiments of the thrusting assembly, said combustion component comprises a nozzle, wherein the air mass flow is heated to thereby accelerate within said nozzle, e.g. to hypersonic velocities.

In some embodiments of the thrusting assembly, said one or more actuator disc arrangements are configured to allow hypersonic flow rate of air mass therethrough.

In some embodiments of the thrusting assembly, said one or more fluid-based rotary actuators are operable to obtain said hypersonic flow.

In some embodiments of the thrusting assembly, said aerial platform is an autonomous aerial platform or aerial vehicle.

In some embodiments of the thrusting assembly, propulsive force of the thrusting assembly comprises a disc loading profile controlled by at least one characterization of said one or more actuator disc arrangements: an instant torque, instant angular torque, alternate instant angular torque, instant rotational speed, global rotational speed, or any combination thereof.

In some embodiments of the thrusting assembly, the thrusting assembly is configured to generate autorotation energy in response to autorotation of the one or more fluid-based rotary actuators, namely passive rotation of the blades, e.g. while the aerial platform is descending.

In some embodiments of the thrusting assembly, said autorotation energy is either being directly used to drive said one or more fluid-based rotary actuators or stored in an energy storage of the thrusting assembly for later use.

In some embodiments of the thrusting assembly, said one or more actuator disc arrangements comprise one or more tandem actuator disc arrangements, each has a pair of coaxial actuator disc arrangements members.

In some embodiments, the thrusting assembly comprises an odd number of said one or more tandem actuator disc arrangements.

In some embodiments of the thrusting assembly, each member of the pair of coaxial actuator disc arrangements is configured to rotate in an opposite direction to the other member.

In some embodiments, the thrusting assembly comprises one or more powerplant units. The powerplant may be an integral part of the aerial platform in other the embodiments powerplant external to the moving platform and may be grounded or part of another vehicle or a fixed structure.

Yet another aspect of the present disclosure provides an aerial platform or aerial vehicle. The aerial platform comprises the thrusting assembly of any of the above-described embodiments or any combination thereof. The aerial platform further comprises a platform mission and application utility configured to operate a desired operation while the aerial platform is airborne.

In some embodiments of the aerial platform, the platform mission and application utility is driven by the energized working fluid supplied from the source of energized working fluid. The platform mission and application utility may carry out any robotic application, such as collecting fruits, drilling, etc.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIGS. 1A and 1B are block diagrams exemplifying different non-limiting embodiments of the thrusting assembly of the present disclosure.

FIG. 2 is a schematic illustration of a non-limiting example of a thrusting assembly according to an aspect of the present disclosure.

FIG. 3 is a schematic illustration of a non-limiting example of a thrusting assembly according to an aspect of the present disclosure.

FIG. 4 is a schematic illustration of a non-limiting example of an operation scheme of the valving mechanism of the thrusting assembly of the present disclosure.

FIGS. 5A-5B are schematic illustrations exemplifying a non-limiting embodiment of a thrusting assembly according to an aspect of the present disclosure.

FIGS. 6A-6B are schematic illustrations exemplifying different non-limiting realizations of a thrusting assembly according to an aspect of the present disclosure.

### DETAILED DESCRIPTION OF EMBODIMENTS

The technique of the present disclosure provides a novel approach for construction and operation of a moving platform for transporting various things. This technique provides a Fluid Powered Thrust Vectoring Systems (FTVU) that can be attached to/mounted on a moving platform (e.g., robot).

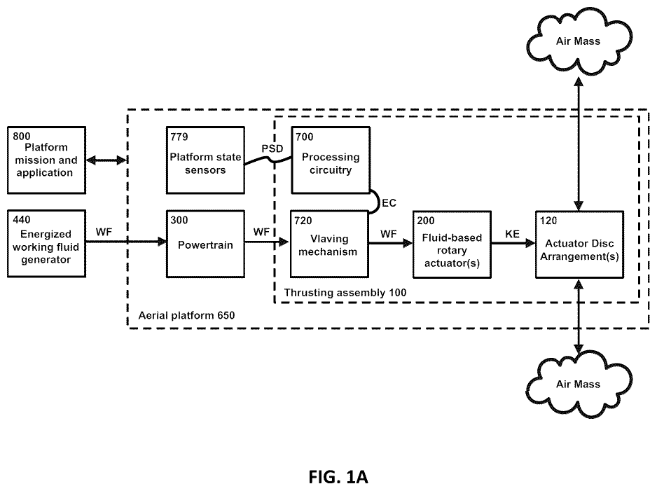

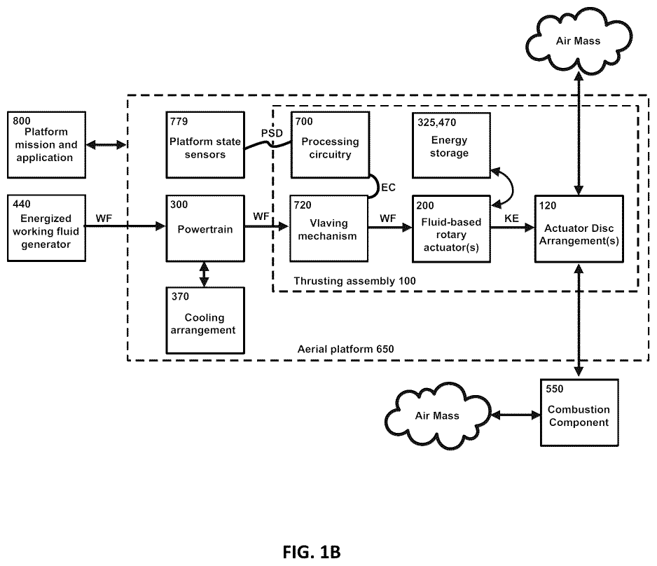

Reference is made to FIGS. 1A-1B, which are block diagrams of non-limiting examples of a thrusting assembly 100 configured and operable according to the present disclosure. The thrusting assembly is mounted on an aerial platform 650.

FIG. 1A shows a thrusting assembly 100 that comprises one or more fluid-based rotary actuators 200 that are driven by Working Fluid (WF) supplied from a source of energized working fluid 440 either mounted on the aerial platform 650 or mounted on an auxiliary land vehicle that is connected to the aerial platform 650. The working fluid WF, which may be liquid for hydraulic realization or gas for pneumatic realization of the fluid-based rotary actuators 200, is delivered to a power train 300 that is configured, in turn, to controllably supply the working fluid WF to the fluid-based rotary actuators 200 by controllable valving mechanism 720 that is controlled by a processing circuitry 700 (at times referred to below as a computer system or control system). The processing circuitry 700 is configured to control the valving mechanism 720 by Execution Commands (EC) that are transmitted to the valving mechanism 720 and causing the valves in the valving mechanism 720 to open and close, thereby allowing controllable flow rate of energized working fluid WF to flow towards the fluid-based rotary actuators 200.

The processing circuitry is in data communication with a plurality of platform state sensors 779 that are configured to sense the aerial platform state of the aerial platform and generate Platform State Data (PSD) and to transmit it to the processing circuitry 700. The platform state data PSD may include any one of the following: position data of the platform, e.g. the tilt of the platform, the air velocity of the platform, the ground velocity of the platform, the pitch, roll and yaw of the platform, the angular position of each of the fluid-based rotary actuators, the angular position of each of the actuator disc arrangements or any combination thereof. Based on the platform state data PSD, the processing circuitry 700 is configured to accordingly generate the execution commands EC to result in the desired torque and rotational velocity of the fluid-based rotary actuators 200 to achieve a desired flying pattern or profile. The execution commands EC can be in the form of Pulse-width modulation (PWM), or pulse-duration modulation (PDM) techniques.

The fluid-based rotary actuators 200 are coupled to one or more actuator disc arrangements 120 that are rotatable by kinetic energy KE delivered to them by the fluid-based rotary actuators 602. In result to the rotation of the actuator disc arrangements 120, air mass flows through them and causes an acceleration of the aerial platform or desired maneuver thereof.

It is to be noted that in some embodiments, the platform state sensors 779, or at least some of them, can be part of the thrusting assembly 100. Furthermore, in some embodiments, the source of energized working fluid 440 can be part of the thrusting assembly 100.

The power train 300 should be broadly interpreted as a delivery tool for delivering the energized working fluid, which can be a duct, for example or an array of ducts. The energized working fluid can be generated by an energized working fluid generator 440 which may not even be mounted on the aerial platform 650. For example, the aerial platform 650 can be coupled to a land-based vehicle that comprises said energized working fluid generator 440 and deliver it to the source of energized working fluid 440 on the aerial platform 650. Though, in some embodiments, the energized working fluid generator 440 can be on the aerial platform 650 itself. The energized working fluid generator 440 may be a pump or an array of pumps that are configured to elevate the pressure of the working fluid WF, e.g. a working liquid, and to deliver it in a suitable flow rate to the power train 300.

The aerial platform 650 may be couplable with or integral with a platform mission and application utility 800 that is capable of performing a selected operation, such as drilling, cutting branches, collecting fruits, or any other desired application. This platform mission and application utility 800 is configured to be powered by the working fluid WF that is supplied to the aerial platform 650 and the thrusting assembly 100 by the energized working fluid generator 440. Furthermore, the control of the power supply and optionally the control of the operation itself may be performed by the processing circuitry 700 of the thrusting assembly 100.

Reference is now being made to FIG. 1B, which differs from FIG. 1A by including a cooling arrangement 370, a fluid energy storage 325 and a combustion component 550. The cooling arrangement 370 is configured to receive a portion of the working fluid WF, cool it and return it back to further use in the thrusting assembly 100. This is required due to the heating of the working fluid WF while it operates in the thrusting assembly 100.

The fluid energy storage 325 is configured to store energy EN and deliver it when it is required. The energy storage 325 is used to store energy EN that is generated due to autorotation of the actuator disc arrangements 120, e.g. while the aerial platform 650 descends, therefore its potential energy is transformed into Kinetic Energy (KE) and the fluid-based rotary actuators 200 are configured to serve also as electric generators when driven by the actuator disc arrangements 120 and the energy EN they produce is delivered to be stored in the electrical energy storage 470.

The combustion component 550 is arranged such that it is configured to receive the air mass flow that is moved by the actuator disc arrangements 120, namely the combustion component 550 is downstream the actuator disc arrangements 120 along the air mass flow path. The combustion component 550 is configured to heat the air mass that is received therein to accelerate it through a nozzle (not shown) that is part of the combustion component, thereby allowing accelerating the air mass to hypersonic speed.

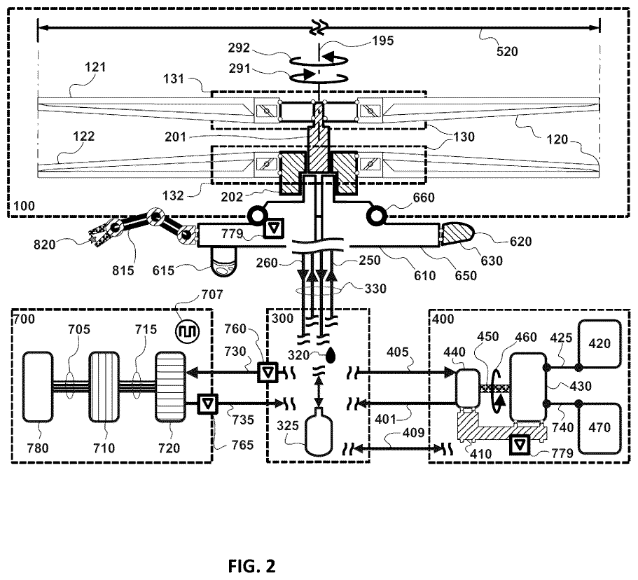

Various specific but not limiting examples of the configuration and operation of the thrusting assembly/system of the present disclosure are described below with reference to FIGS. 2-4, 5A-5B, and 6A-6B.

It is to be noted that if the disclosure refers to a specific figure and an element does not appear in the figure, the teaching of such an elements should be done from a figure it appears on.

In some embodiments of the technique/system of the present disclosure the FTVU 100 is driven by a fluid powertrain, fluid drivetrain and/or fluid transmission subsystem 300 that may include, but not limited to be a part of an autonomous robotic moving platform 650 or any vehicle to move, maneuver, hover, fly and be subject to thrust force and/or be projectile. The configuration and operation of the FTVU 100 described herein allows autonomous robotics applications or any moving platform 650 to accelerate faster and accurately in all 6 degrees of freedom (6DOF) in space. Six degrees of freedom (6DOF) refers to the freedom of movement of a rigid body in a three-dimensional space.

Thus, according to a broad aspect of the presently disclosed subject matter, it provides one or more FTVUs 100 configured to be attached to/mounted on a single moving platform and/or a robot 650. Whereas a single moving platform 650 may carry a combination of different types of thrust vectoring systems. For example, a single moving platform 650 may have one or more FTVUs 100 combined with another type of thrust vectoring system. Hence, a single moving platform 650 according to some embodiments of the present disclosure may be further associated with a combination of different types of thrust vectoring systems such as FTVU 100, an Gas Dynamic Steering (GDS), Gas Dynamic Control (GDC), an Electrical powered Thrust Vectoring System (ETVS) 801, a Shaft cupelled Thrust Vectoring System (STVS) with a fueled engine, Propellant Injection vectoring System (PIVS), Vernier Thruster System (VTS) and/or any thrust vector of a rocket nozzle.

A single moving platform 650 may include but not limited to missile, rocket, low orbit satellite, aerospace moving platform/carrier, aerial moving platform, aircraft and/or any type of a flying machine and/or a vehicle. The moving platform 650 with the attached FTVU 100 introduced here may travel through atmospheric air on and around the planet earth, and/or on any planet within the solar system and/or in space between planets.

In some embodiments, as illustrated in FIG. 2, the FTVU 100 has an Actuator Disc 120 configuration of coaxial/coax rotors and/or tandem rotors and/or Intermeshing rotors resulting in disc loading 500 with radial area of 520. The two coaxial/coax rotors, 121,122 may rotate in the opposite directions 291, 292 on a rotational axis 195 of the fluid powered thrust vectoring unit (FTVU) 100. The FTVU 100 in the example shown in FIG. 2 includes two fluid actuators 200, each connected to a teetering hinge rotor/blade system 120. As illustrated in FIG. 2, the fluid actuator 201 is coupled mechanically 130 with the rotor 121 by a passive teetering hinge mechanism 131. Similarly, a hollow shaft fluid actuator 202 is coupled with a mechanical hub 132 to the passive rotor system 122.

In some other embodiment, as illustrated in FIG. 2, the fluid powered thrust vectoring unit (FTVU) 100 is attached to the moving platform 650 by a mechanical joint 660. The moving platform in FIG. 2 has payload 615 and wings and control surfaces 620. Alternatively, in configurations as illustrated schematically in FIG. 2, a computer system 700 and/or a drivetrain/powertrain 300 and/or a powerplant 400 may be part of the thrust vectoring units (FTVU) 100 and/or part of the moving platform 650 and/or part of the payload 615 and/or part of vectoring units (FTVU) 100 main application 815 and/or the main application 815 payload and remote job 820.

Thus, according to the present disclosure, the thrust vectoring unit (FTVU) 100 may be powered by unknown powerplant 400 whereas the powertrain 300 acts as a network of piping 330 and/or fluid lines 401,409, 325, 730, 735, 250, 260 and/or internal parts and accessories of such devices as fluid actuator 200, fluid transmission subsystem 130, fluid pump 440 and fluid valving device 720. In other cases, where there is no powerplant 400 connected, the FTVU 100 may be powered only by a pressurized tank 325 or accumulator 325 part of the powertrain 300 network of fluid lines. In other cases, where the powerplant 400 is connected with the powertrain 300, as shown in FIG. 2, the accumulator 325 configuration, part of the powertrain 300 may power and regulate one or more fluid actuators 200 part of the FTVU 100, while connected in a parallel manner and/or in a serial manner and/or directly and/or indirectly with the powerplant 400 fluid lines 401,405 and 409.

Referring again to the non-limiting example illustrated in FIG. 2, the computer system 700 may be part of FTVU 100 and/or of the moving platform 650 and/or part of the payload 615 and/or part of the main application 815, 820. The computer system 700 has a fluid valving device 720 that is connected to a powered electronics board 710 managed by a real-time software 780. The software 780 operates on the computer system 700, sends and receives signals, being digital, optical, analogue and/or Radio frequency (RF) signals, via embedded cables 705 and/or via connections 705 and/or via wireless link 705 from and to the powered electronics board 710.

In some embodiments and as illustrated schematically in FIG. 4, the powered electronics board 710 translates and computes the signals, data and information received from the software 780 into powered electrical signals 711,719 in one or more different methods and configurations of control system 717 and 713 as shown in FIG. 4. These examples of powered electrical signals 711,719 are applied in Watts per second, voltage per second and/or ampere per second on the electro-mechanical valving device 720.

Referring again to the non-limiting embodiment illustrated in FIG. 2, these powered electrical singles 711,719 generated by the power electronics board 710 are transferred via the connections 715 and applied on the electro-mechanical valving device 720. The valving device 720 converts the electrical power and/or the signals 711,719 in Watts per second received from the power electronics board 710 into mechanical energy that acts as a valve mechanism on the working fluid 320 entering the valving device 720. The working fluid 320 enters the device 720 via an inlet port 730 and an outlet port 735 from the powertrain 300 network of pipes 330.

In some embodiments, not specifically shown in FIG. 2, the valving device/mechanism 720 may operate within the fluid actuator 200 itself, within the hub mechanism 130, within the powertrain 300 accessories and/or within the powerplant 400 components. Alternatively, as illustrated schematically in FIG. 2, the computer system 700 may be an embedded part of FTVU 100 and/or may be configured as a modular part of the moving platform 650 and/or the moving platform application 815.

Additionally, or alternatively, the fluid entering via line 730 into the valving device 720 is measured by a fluid sensor 760 of the computer system 700. Similar, the working fluid 320 leaving the valving device 720 via the fluid line 735 is measured in real-time by a fluid sensor 765. These fluid sensors 760 and 765, part of the computer system 700, are configured for measuring the performances of the valving device 720 and/or the working fluid 320 properties such as: temperature, pressure, volume rate and/or physical status before and after entering and leaving the electro-mechanical valving actuator mechanism 720.

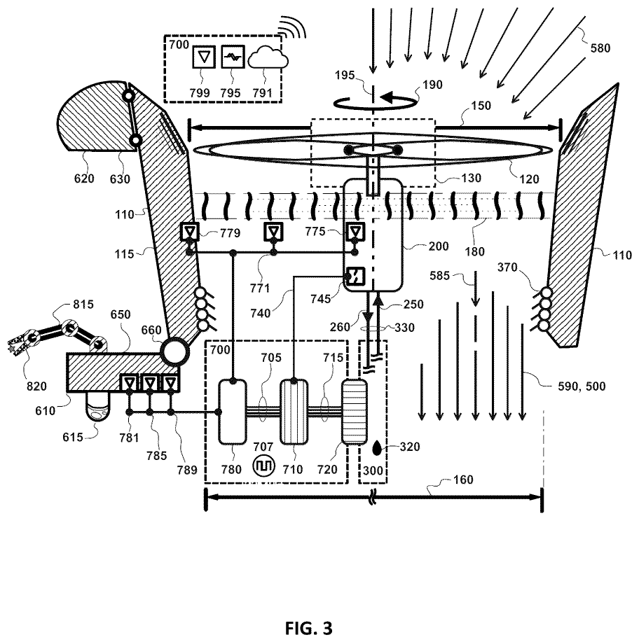

In another embodiment, illustrated in FIG. 3, the electro-mechanical fluid valving device 720 may be connected directly with inlet port 250 of the fluid rotary actuator 200, being part of the powertrain 300 configuration. In other cases, as shown in FIG. 4, this valving device 720 may drive the fluid rotary actuators 200 with a Pulse-width modulation (PWM), or pulse-duration modulation (PDM) manner, where fast, real-time modulation in volume 220 and/or pressure 230 takes place.

Thus, according to the present disclosure and as exemplified in FIG. 2, the fluid actuators 201, 202 within the FTVU 100 may be feed via the intake port 250 and/or restricted via the outlet port 260 and/or directly connected to the powertrain 300 fluid lines 730,735,405,401,409, 730, 735 and/or 325.

As further shown in FIG. 2, the powerplant 400 may have one or more energy containers storage 420 or fuel tank(s) 420. This fuel tank 420 is connected by piping hardware 425 and/or a fuel feeder machinery 425 to an engine 430 that converts the chemical energy of the fuel in the storage 420 in thermodynamically manner by doing combustion and/or mixing one or more types of fuels and gases into useful mechanical energy 460. In some embodiments of the powerplant 400 configuration, an electrical utility power socket 470 and/or fuel cell 470 and/or battery 470 and/or any type of chemical energy storage of electrons and electrical power 470, may provide the electrical motor 430 with electrical power. In some embodiments, the electrical motor 430 converts the electrical energy received from the battery 470 via the grid cables 740 into useful mechanical energy 460.

Hence, the useful mechanical energy 460 generated by engine 430 and/or motor 430 is then transferred into the fluid pump 440 by a mechanical coupler 450. The useful mechanical energy 460 derived by the mechanical coupler 450 is applied on the pumping mechanism 440. As a result, the pumping mechanism 440 energizes the fluid that enters the pump 440 from the powertrain 300 via the inlet line 405 and leaves the pump via the outlet fluid line 401. Similar, the pumping mechanism 440 may create a pressure difference and/or a volume movement between the fluid entering the pump 440 via the inlet line 405 and the energized fluid leaving the pump via the outlet fluid line 401.

Thus, according to the present disclosure, the powertrain 300 may accommodate different types of working fluid 320, such as air and/or oil and/or any type of liquids and gases. Additionally, or alternatively, the powertrain 300 may be configured as an open loop system and/or closed loop system with one and more layers of network of piping 330. In some cases, the additional layers of piping 330 and accessories, part of the powertrain 300 subsystem, may serve purposes of cooling 370 by heat pump fluids and/or by the working fluid itself 320. Similar, the powertrain 300 may include lubrication setup, additional piloting lines form actuators 200 and pumps 440 and/or the powertrain 300 may include high, medium, low and negative pressurized fluid lines.

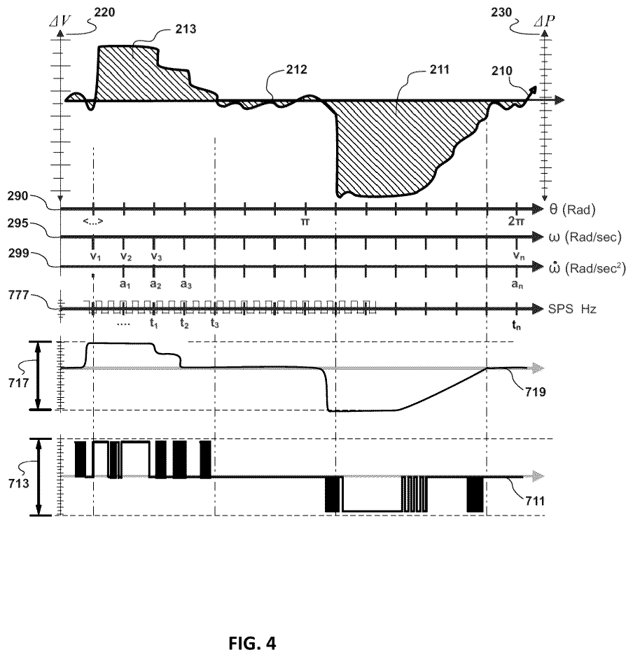

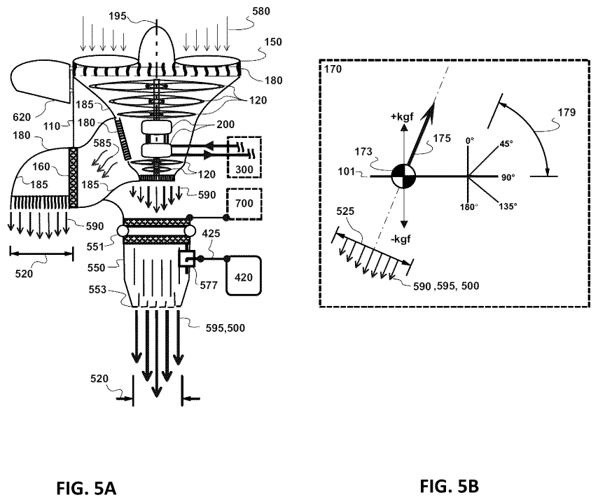

According to the present disclosure, as illustrated in FIG. 5A, an afterburner nozzle configuration 500 is used by arranging a nozzle afterburner setup 550 on the outlet 160 of the FTVU 100. This nozzle vectoring unit (FTVU) 100 arrangement includes a fan actuator disc 120 powered by a fluid actuator 200 with afterburner 550, which allows the vectoring unit (FTVU) 100 and/or the moving platform 650 to accelerate fast with additional 3 times thrust-to-weight ratio during afterburner 500 activation. Similarly, an afterburner activation may provide an additional +500 km/h on top of 1000 km/h absolute speed of the vectoring unit (FTVU) 100 and/or the moving platform 650, while the disc loading configuration 500 is a fan.

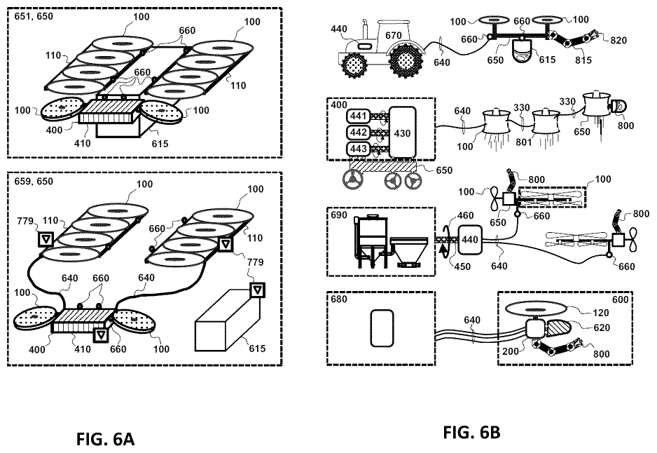

Alternatively, in configurations as illustrated schematically in FIGS. 5A-5B, the arrangement 500 of the nozzle vectoring unit (FTVU) 100 allows hypersonic speeds by redirecting the intake 150 air mass 580 of the vectoring unit (FTVU) 100 to pass and flow directly through the nozzle 550 configuration using active fluid stator 180 and a built-in hypersonic channel 185, as not shown in FIGS. 6A-6B.

The autonomous robotic applications 800 in the present disclosure may include one or more fluid powered thrust vectoring units (FTVU) 100 attached on a single moving platform and/or autonomous robot 650. Each Fluid thrust vectoring units (FTVU) 100 may have different or similar Disc loading configuration 500. Each Fluid thrust vectoring units (FTVU) 100 attached on the single moving platform 650 may have different or similar power output or may have different or similar thrust force profile 525, shape, and size 520 of the disc loading 500, and may have different or similar type of working fluid 320 types and may have different or similar thrust force output 170 as means of mass air flow 590, 595.

The technique of the present disclosure may utilize one or more fluid powered thrust vectoring units (FTVU) 100 attached to an aircraft, aerial and/or aerospace vehicle and/or moving platform 650. One or more attached thrust vectoring units (FTVU) 100 allows the moving platform 650 to projectile, lift, hover, move, taxi, fly, float, dive, tilt, Yaw, Roll, Pitch, maneuver and navigate in 6DOF in space.

Referring to the non-limiting example illustrated in FIG. 5B, the thrust force output 170 of vectoring units (FTVU) 100 refers as thrust force vector or propulsive force 170 derived from the acceleration of the air mass outlet flow 590, 595 of the vectoring unit (FTVU) 100. The force output 170 of the vectoring unit (FTVU) 100 is represented by the disc loading 500, shape 520 and profile 525 measured relative to the vectoring unit (FTVU) 100 geometry 101. The thrust vectoring unit (FTVU) 100 generates a controllable propulsive force 170 with variable thrusting acceleration, which provides the moving platform 650 fast changing linear and angular acceleration values while it maneuvers in 6DOF in space.

In some embodiments, as illustrated in FIG. 5B, the force vector 170 size 175 or amplitude 175 is measured by Newtons or kg. The force vector 170 is a physical representation of the air mass flow 590,595 kinetic and thermodynamic energy combined in the form of acceleration in m/sec² times the mass of the air leaving the thrust vectoring unit (FTVU) 100 through the nozzle configuration 550, 553 and/or the exhaust 160 of the vectoring unit (FTVU) 100 as exemplified in FIG. 5A. The force vector 170 size or amplitude 175 may have geometrical relations 101 with the center of gravity and/or second moment of area and/or polar angular momentum and/or center of moment of inertia and/or gyroscopic axis and/or center of lift (CL) of the vectoring unit (FTVU) 100 and/or of the moving platform 650.

Similarly, the force vector 170 angle 179 and/or angular direction 179 is measured by Radians, where the force vector 170 point of origin 173 is measured relative to the thrust vectoring unit (FTVU) 100 geometrical structure 101 and/or with relation to the center of gravity and/or second moment of area and/or polar angular momentum and/or center of moment of inertia and/or gyroscopic axis and/or center of lift (CL) of the vectoring unit (FTVU) 100 and/or of the moving platform 650.

Thus, according to the present disclosure, the origin 173, angle 179 and magnitude 175 of the Propulsive force 170 of the vectoring unit (FTVU) 100, may refer to one or more thrust vectoring unit (FTVU) 100 combined and/or may refer to the moving platform 650 mass distribution, thermodynamic and aerodynamic properties relative to all types of three dimensions (3D) axes and coordinates 101, and/or relative to a quaternion force 170 representation in 6DOF.

In some embodiments, a combination of one or more fluid powered thrust vectoring units (FTVU) 100 are attached on a single moving platform 650, which may result, but not limited to a Vertical Take-Off and Landing (VTOL) vehicles and/or allows short take-off and landing (STOL) for any type of moving platform 650 such as, a piece of mechanized equipment 670, 690 of carrying or transporting something, on ground, at sea and/or through air. For example, in some embodiments, the powerplant 400 subsystem being a part of the moving platform 650 may be able to short take-off and landing while the rest of the moving platform 650 may a Vertical Take-Off and Landing (VTOL).

Additionally or alternatively, in some embodiments, aerial mechanized equipment, aircraft and/or aerospace vehicle and/or moving platform 650 may use thrust vectoring unit (FTVU) 100 with combination of ailerons and/or elevators through aerodynamic deflection using rudders, flaps and/or any other combination of aircraft control type of flight control surfaces 620 in order to aerodynamically control the force output 170 of the vectoring unit (FTVU) 100 and/or dynamics of the moving platform 650 in space. The aerodynamic surface controls 620 may interact with the air that may have different levels of air densities, air pressures and air temperatures. Hence, thrust vectoring unit (FTVU) 100 with or without attached controlled surfaces 620 allows the moving platform 650 to maneuver in 6DOF while controlling the moving platform 650 angle of attack, providing additional stabilization and/or managing the landing, lifting and the change in potential energy of the moving platform 650 itself.

Further according to some embodiments of the technique of the present disclosure, an aerial and/or aerospace moving platform 650 may have one or more fluid powered thrust vectoring units (FTVU) 100 attached on a single moving platform 650. Each thrust vectoring unit 100 may have its own mainframe 110. The attached thrust vectoring system 100 may gimbal, tilt, flip, flap, align, move and rotate while physically connected with the joint connector 660 part of the moving platform 650 mainframe 610 as shown for example in FIG. 2 and FIG. 3.

According to some embodiments, the Fluid powered thrust vectoring unit mainframe 110 is the moving platform 650 itself. For example, the fluid powered thrust vectoring units (FTVU) 100 may be part of the moving platform 650, body/mainframe 610, landing gear, control surfaces 620, rotating cylinder structure, fuel-tank 420, engine batteries 420 and/or wings 630 and/or parashot configuration. Additionally, or alternatively, in some embodiments, the thrust vectoring units 100 mainframe 110 may act aerodynamically and thermodynamically to simulate a duct casing 115 configuration, part of the moving platform 650 mainframe 610.

Thus, according to the present disclosure, the fluid thrust vectoring unit (FTVU) 100 may have a total specific power and/or power density between 6 kg/kW to 0.01 kg/kW depending upon the vectoring unit (FTVU) 100 total mass in kg and the attached mass to the vectoring unit (FTVU) 100. The vectoring unit (FTVU) 100 specific power also depends upon the vectoring unit (FTVU) 100 geometrical configuration 101 such as the fluid rotary actuator 200 properties, the type of the working fluid 320 and Actuator Disc 120 disc loading configuration 500.

In some embodiments, as illustrated in FIG. 5A, a total Power-to-weight ratio (PWR), specific power, or power-to-mass ratio can reach 100 kW/kg when chemically powered propellants and/or bipropellant combinations and/or fuel mixed with oxidizer may be used in nozzle configuration 550. This vectoring unit (FTVU) 100 arrangement is similar to turbofan with afterburner setup.

According to the present disclosure, and as illustrated schematically in FIG. 5A, the fan configuration in this example has a number of Actuator Discs 120 coupled mechanically with the rotary actuator 200, whereas the Afterburner is the nozzle configuration 550. In the nozzle configuration 550, a combustion unit 577 is configured to burn fuel from the fuel tank 420 to heat air received in the nozzle to accelerate it, optionally to hypersonic velocities.

In some non-limiting examples, there is joint operation 660 between two or more solids such as the fluid thrust vectoring unit (FTVU) 100 and between the moving platform 650. The joint operation 660 is done by introducing a mechanical movement and motion between the moving platform 650 and the vectoring unit (FTVU) 100 itself which results in managing and directing the force output 170 generated from one or more thrust vectoring unit (FTVU) 100 attached on the moving platform 650. In some embodiments, a combination of the mechanical joint 660 may comprise gimble mechanism, prismatic joint, pin joint, ball joint, knuckle joint, turn buckle cotter pin bolted, universal joint, U-joint and/or fluid actuator and/or electrical actuator.

Additionally, or alternatively, as shown in FIG. 6A, the Joints 660 on the moving platform 659 may be part of a cable reels, keeping the pipes (330) and other cables/and connection (715,740,705) illustrated here as lines 640. The joint cables 640 are connected between the modular moving platform 659 and/or between the modular setup of thrust vectoring unit (FTVU) 100. This modular setup of the moving platform 659 may allow the thrust vectoring unit (FTVU) 100 or multiple thrust vectoring units (FTVU) 100 to operate while the moving platform 650 may be detached from the application task 820 and/or detached from the main application robotics hardware 815 and/or detached from the moving platform payload 615 and/or detached from the from the moving platform 650 and/or detached from the powerplant 400. Each mechanical joint 660 may include a set of motion sensors 779 measuring the joint 6DOF movements. This allows to measure the weight of the payload 615 and/or the main application 815 forces and torque. The sensor motion 779 may measure an additional information in real-time 777 such as the moving platform 650 angle of attract relative to the total thrust vector 170 of the total moving platform and/or the thrust vector 170 of each detached thrust vectoring unit (FTVU) 100.

Referring again to the non-limiting embodiment illustrated in FIG. 6A, the fluid thrust vectoring unit (FTVU) 100 may be attached to the powerplant 400 mainframe 410 by the joint 660 as shown in the moving platform 659. This joint operation 660 allows the powerplant unit 400 to hover by itself with less than 1 kg/kW specific power. At this specific power density for example, the powerplant unit 400 may comprise number of masses added together such as fuel tank 420,425 as its energy source, engine 430 and a fluid pump 440 part of the powertrain 400 main components. However, when the hovering detached powerplant 400 fastened itself on a payload 615, illustrated in FIG. 6A as a moving platform 651, the payload itself becomes the moving platform 650 main frame 610. While the modular powerplant 400 is hovering with the attached payload 615, the total moving platform 651 specific power may reach 6 kg/kW. According to some embodiments, the mechanical joint 660 may be part of the unit 100 mainframe 110,115 and/or part of the payload 615 and/or any part of the moving platform 650 such as control surfaces 620, wings 630, payload 615 and/or its mainframe 610 and/or the applications of the moving platform 815,815.

According to some embodiments of the present disclosure as illustrated in FIG. 3, the intake area 150 in meter square of the thrust vectoring units (FTVU) 100 allows air mass flow 580 to enter the thrust vectoring unit (FTVU) 100 and exist the unit 100 through the unit outlet 160 area as an accelerated air mass flow 590, creating a Propulsive force 170.

Additionally, or alternatively, vectoring unit 100 may comprise built-in channels 185 shown for example in FIG. 5A that may include one or more intake ports 150 and one or more outlet ports 160 to coexist on a single thrust vectoring unit (FTVU) 100 and/or moving platform 650.

Referring again to the non-limiting example illustrated in FIG. 3, in some other cases, the air fluid stator 180 configuration may be used as the thrust vectoring units (FTVU) 100 mainframe 110. In some embodiments, the stator configuration is an active air stator 180 and may adjust its angle of attack actively, dynamically and in real-time by sending and receiving information from the computer system 700. The activation and control of the stator 180 configuration may be managed by the computer system 700 real-time decision-making software 780 and/or based upon information received by set of sensors 771 measuring the air mass 580,585,590 temperature, pressure and velocity/acceleration before and after passing the stator 180 configuration of unit 100.

In some embodiments, a combination of air fluid stator configuration 180 may be part of the thrust vectoring unit (FTVU) 100 mainframe 110 and/or part of the moving platform 650 and/or part of the moving platform mainframe 610. The air fluid stator configuration 180 may provide a laminar air flow of the air mass 580 before entering the thrust vectoring unit (FTVU) 100 and/or while the air mass flow 585 travels within the thrust vectoring unit (FTVU) 100 and/or while the air mass 590,595 is leaving or exiting or exhausting the thrust vectoring unit (FTVU) 100. In some embodiments, the air fluid stator configuration 180 may act as rudders configuration of the air mass 590,595 leaving the thrust vectoring unit (FTVU) 100 as for example shown in FIG. 5A.

The fluid thrust vectoring unit (FTVU) 100 may comprise an Actuator Disc 120 or combination of one or more discs such as Propeller, Rotors, Prop, fan, Airscrew, set of blades and/or any actuator disk whose working fluid is atmospheric air. When the Fluid Rotary Actuator 200 rotates, the Actuator Disc 120 provides movement of air mass flow 580,585,590 throughout the fluid thrust vectoring unit (FTVU) 100.

Hence, the thrust vectoring system 100 may be built from a mainframe 110 attached to the moving platform 650. In some embodiments of the present disclosure the fluid thrust vectoring unit (FTVU) 100 may be constructed with an aerodynamic structure in mind, for example a duct aerodynamic structure 115 while one or more Actuator Discs 120 are rotating within the fluid thrust vectoring unit (FTVU) 100 in opposite directions. This Coaxial Actuator Discs 120 and/or tandem rotors 120 configuration also known as coaxial/coax rotors and/or tandem rotors and/or Intermeshing rotors may provide the thrust vectoring unit (FTVU) 100 with no gyroscopic force, torque axis cancelation and doubling the effective area of disc loading 520 when compared to a single Actuator Disc configuration 120.

In some embodiments of the present disclosure as illustrated in FIG. 2 and FIG. 3, the coupled mechanism 130 may couple mechanically the Actuator Disc 120 with the Fluid Rotary Actuator 200. This allows the Actuator Disc 120 to get its power and/or torque and/or its rotational motion in a form of mechanical energy from the coupled Fluid Motor 200 or a Fluid Shaft Drive Motor 200 or a Fluid Rotary Actuator 200. Additionally, or alternatively, the coupled mechanism 130 may be an integral mechanical part of the Actuator Disc 120 and/or may be an integral element of the Fluid Rotary Actuator 200. In some cases, but not limited to current innovation, the coupled mechanism 130 may comprise of a gear, gearbox, colloquially gear, a Jesus nut, freewheeling unit, belt and pulley configuration, mast, drum, shaft rods, cupelling shaft and other transmission mechanism, teeter link, scissor link, swashplates, hinges and/or mechanical bearing such as plain bearing, Ball bearing, roller bearing, rolling-element bearings, rollers Fluid, Flexure bearing, ceramic bearings, journal bearing, sleeve bearing, rifle bearing, composite bearing, a noncontact bearing and/or a magnetic bearing.

In some embodiments of the present disclosure, the Actuator Disc 120 is driven and powered mechanically by kinetic energy derived from the attached Fluid Rotary Actuator 200. One Actuator Disc 120 may be powered and driven by one or more Fluid Rotary Actuators 200. In some other non-limiting examples, Fluid Rotary Actuators 200 may power and drive one or more Actuator Discs 120. The Fluid Rotary Actuators 200 may couple and transfer mechanical energy and motion to the Actuator Disc 120 such as force, velocity, acceleration, torque, angular momentum, linear momentum, angular acceleration and/or any other type of mechanical energy and motion.

In a similar manner, the Actuator Disc 120 may be powered by air mass flow 580 which forces itself into the thrust vectoring unit (FTVU) 100. This forced air mass flow 580 may be generated by the motion of the moving platform 650 in space and/or when the vectoring unit (FTVU) 100 loses potential energy. As a result, this forced air mass flow 580 forces the actuator disc 120 to rotate. This autorotating of the actuator disc 120 within the unit 100 creates a mechanical energy on the coupled Fluid Rotary Actuator 200 forcing it to act as a fluid pump. As a result, the accumulated mechanical energy generated on the Fluid Rotary Actuator 200 is then converted into fluid energy, as an energized working fluid 401 on the powertrain 300.

Thus, according to the present disclosure, when the forced air mass 580 enters the unit (FTVU) 100, the forced Fluid Rotary Actuator 200 generates energized fluid 401 and sends it to the powerplant 300 via the piping network 330. At the same time, the powertrain 300 may distribute the generated energized fluid 401 to the neighboring fluid thrust vectoring units (FTVU) 100 which is attached on the moving platform 650. This autorotation configuration may allow one unit (FTVU) 100 to generate fluid energy, while the second neighboring fluid thrust vectoring units (FTVU) 100 may use this generated fluid energy to create a thrust vector 170. According to some embodiments, the generated energized fluid 401 by the forced Fluid Rotary Actuator 200 may be transferred to the powertrain 300 and stored as fluid energy within a fluid storage 325 and/or accumulator 325 and/or return tank 325 part of the powertrain 300.

For example, a forced air mass 580 may pass through a thrust vectoring unit (FTVU) 100 while the moving platform 650 losses or experiences changes in potential and kinetic energy. This may take place while the moving platform 650 is during braking and/or during gliding and/or parachuting and/or while the moving platform 650 may change its angle of attack.

Thus, according to the present disclosure, this event of a forced air mass 580 passes through a thrust vectoring unit (FTVU) 100 which may take place while other vectoring thrust systems 801 and/or one or more thrust vectoring units (FTVU) 100 on the moving platform 650 are still in operation and/or creating thrust forces. The fluid thrust vectoring units (FTVU) 100 that a forced air mass 580 passes through may generate energized fluid 401 by the forced rotation of Actuator disc 120 derived by the forced air mass flow 580 passed thought thrust vectoring units (FTVU) 100. In a similar manner, an electrical vectoring thrust system 801 attached to the moving platform 650 may generate electrical power on the electrical grid 740 from the energy of a forced air mass 580 passing through.

In some embodiments of the present disclosure, the Actuator Disc 120 is driven and powered by the Fluid Rotary Actuator 200. In other cases, the actuator disc 120 may autorun or freewheeling by the forced air mass 580 entering the thrust vectoring unit (FTVU) 100. Additionally, or alternatively, the torque generated by the actuator disc 120 from the forced air mass 580 may be equalized with the fluid rotary actuator 200 torque output 190 and even exceed the stall torque 190 of the rotary actuator 200.

Referring now to FIG. 4, according to the present disclosure, fluid rotary actuator 200 may change, alternate, pause, break, interrupt, start, activate its driven torque 210 based upon the fluid rotary actuator 200 and/or the Actuator Disc 120 angular position 290 and/or angular velocity 295 and/or angular acceleration 299. This allows management and control of the air mass passing 585 through the unit 100 and creating the thrust vector 170. The driven torque 210 generated by the fluid rotary actuator 200 may be controlled by the energized working fluid 401 entering the rotary actuator 200 and/or by the working fluid leaving 409 the rotary actuator 200.

Since the fluid rotary actuator 200 can operate on a stall torque 190 if needed, the thrust vectoring unit (FTVU) 100 can pause instantly the motion of the actuator disc 120 at a particular angular position 290. The instant pause of the actuator disc 120 by the rotary actuator 200 may convert the stationary actuator disc 120 to control surfaces 620 and/or a stator configuration 180 and/or wings 630. Similar, the thrust vectoring unit (FTVU) 100 can instantly create a negative instant torque 211 and/or instantly create an opposite mechanical motion which in turn slowdowns the rotational speed of the disc 120 or even rotates the actuator disc 120 in the opposite direction. This instant torque 210 may instantly generate a negative amplitude 175 of its thrust force 170 of the thrust vectoring unit (FTVU) 100. Similarly, the fluid rotary actuator 200 can disengage the torque 212 from the actuator disc 120 allowing the disc 120 together with the rotary actuator 200 to autorun or freewheeling without introducing kinetic energy to the working fluid 409 entering the actuator 200 and/or without introducing kinetic energy to the working fluid 409 existing the actuator 200.

In some cases, but not limited to current innovation, the output torque 210 of the rotary actuator 200, as shown for example in FIG. 4 may result from the working fluid changes in volume 220 and/or the working fluid 409 changes pressure 230 which enters and/or leaves the rotary actuator 200 relative to the rotary angular properties 290,295 and 299 and/or according to time domain 777 driven by the computer 700 real-time clock 707. For example, the angular position 290 of the rotary actuator 200 and/or of the actuator disc 120 may be measured by the set of sensors 775 that measures additional mechanical and fluid dynamic properties of the rotary actuator 200 and/or the actuator disc 120 and/or the working fluid 409 entering and leaving the rotary actuator 200 which enables the computer 700 real-time decision-making software 780 to change and alter the angular instant torque 210.

In another embodiment, illustrated in FIG. 3, the computer 700 real-time decision-making software 780 may change and alter the angular instant torque 210 of the rotary actuator 200 according to the information derived from sensors 781,785,789 which measure the thrust vectoring unit (FTVU) 100 and/or moving platform 650 and/or moving platform 650 mission 800. For example, the navigation sensor 781 such as GPS module, IMU and timekeeping aids on the North East down (NED) coordinates may measure the position on earth and in space. This sensor 781 may provide the real-time clock 707 with astronomical time, allowing the real-time software 780 to determine and filter the motion of the moving platform 650 and/or of the vectoring unit (FTVU) 100 in space and time. The sensor 785 measures motion vectors such as accelerations in 3 degree of freedom (3DOF) and similar angular velocities in 3 degrees of freedom. According to some embodiments, sensor 785 may also measure the physical movement of the wings 630 and/or control surfaces 620 with relations to the moving platform 650 geometrics and/or with relations to the vectoring unit (FTVU) 100 geometrics. Additionally, or alternatively, the sensor 789 may be part of the main application 800 task 815 and/or the application robotics payload or job 820. This set of sensors 789 may include vision hardware, artificial Intelligence (AI) sensors and/or any optical sensing hardware, radio frequency (RF) sensing hardware and embedded electronics hardware for means of communications and computation.

In some other embodiments, exemplified in FIG. 5B, the thrust vector 170 of the vectoring unit (FTVU) 100 has angle 179, and amplitude 175. This vector 170 may be generated by the actuator disc mechanism 120 similar to a helicopter main head system which comprises hinges, swashplate, scissor links, torque link, hub trunnion allows each blade and/or all the blades together to feather, flap and lead/lag in a mechanical manner.

According to the present disclosure, as shown in FIG. 2, the actuator disc mechanism 120 may include monospinner configuration and/or swashplateless rotor configuration which allows each blade and/or all the blades together to feather flap and lead/lag in a passive mechanical manner during a single revolution by changing and alternating the instant angular torque 210 while the disc 120 is in rotation.

Additionally, or alternatively, in a swashplateless rotor configuration 130 as for example shown in FIG. 2, the instant angular torque 210 may alternate, as between opposing angular positions 290 or may vacillate in a single revolution of the teetering hinge angle. This may result in the actuator disc 120 changing its rotating blades from high pitch to low pitch, similar to change the rotor 120 angle of attack for each blade, part of the actuator disc 120.

This may be possible by alternating the actuator disc 120 rotating torque 210 during a single revolution, while keeping the rotation speed of the disc 120 at a constant pace or at a constant Revolution Per Minute (RPM). For example, the rotation speed of the disc 120 is constant when measuring the time it takes to the disc 120 to complete a single revolution in 360 degrees or 2 Pi repeatedly. However, during a single revolution at a particular angular distance 290 or at numbers of angular positions 290, the angular instance velocity 295 may be altered and/or the angular acceleration 299 may be changed. The changes in instance angular velocities and acceleration 295,299 during a single revolution may take place twice or more times per revolution in order to keep a constant rotational speed of the disc 120.

According to the present disclosure, the rotary 200 and the disc 120 may change and alter repeatedly the angular torque 210 according to an angular position 290 which geometrically 101 related to the thrust vectoring unit (FTVU) 100 mainframe 110 and/or to the moving platform 650 mainframe 615 and/or with relations to the vector properties of the thrust force 170,173, 175,179. This change in instant angular torque 210 alongside the angular position 290 of fluid rotary actuator 200 and with a fixed reference to the thrust vectoring unit (FTVU) 100 mainframe 110 and/or geometric 101 may provide real-time adjustment of the disc loading 500 profile 525, size 520 and shape while the disc 120 is rotating.

Thus, according to the present disclosure, the change and alter repeatedly of instant angular torque 210 according to the moving platform 650 aerodynamic needs and mission 800 may be derived from a pressure variation 230 and/or from volume variation 220 of the working fluid 320 entering and/or exiting the fluid rotary actuator 200.

Referring again to the non-limiting embodiment illustrated in FIG. 2, the combined forces such as: an instant angular torque 210, fraction, centrifugal and gyro forces may act at the same time on the blade teetering hinge mechanism 130, 131, 132. When for example the instant torque 210 may change its value, a change in the force summation acting on the blade teetering hinge angle, part of the hinge mechanism 130 may take place too. As a result, the blade connected to the hinge mechanism 130 may vary its angle of attack, resulting in changes in disc loading thrust profile 525 of the thrust vectoring unit (FTVU) 100. This teetering force may act and apply on the disc 120 while in rotation. In some cases, but not limited to current innovation, the teetering hinge angle may have an actuator built in (not shown), part of the hinge mechanism 130 in order to actively correct the teetering angle, in other cases the teetering hinge mechanism 130 may balance itself by the total forces acting on the hinge resulting in changes of the blade angle of attack in real time and with relations to the angular position 290.

According to the present disclosure, as for example shown in FIG. 3, the real-time decision-making software 780 may compute 700 this disc 120 teetering combined forces by fusing information from the sensor 779 which provides in 6DOF tilt, acceleration, gyro and/or Nosie and vibration acting on the thrust vectoring unit (FTVU) 100 mainframe 110 with relations to its geometrical 101 properties. According to some embodiments, sensor 771 provides information about the disc 120 output in real-time, mainly measures the disc loading profile 525 by measuring the air mass 580,585,590,595 stages and thermodynamic status such as temperature, pressure, volumetric flow, air mass and/or air entropy, air humidity/air density. Additionally, or alternatively, the information about the instant angular torque 210 of actuator 200 may be derived from the sensor 775, while still the actuator discs 120 keeps a constant rate of speed rotation measured in RPM.

As illustrated schematically in FIG. 2, according to the present disclosure, two rotary actuators 201,202 may have coupled mechanism 130, 131, 132 with Coaxial Actuator Discs 120, 121,122 within a single thrust vectoring unit (FTVU) 100. For example, a single rotary actuator 202 is a hollow shaft 132 fluid motor 200 which is connected to a swashplateless teetering hinge rotor 132 that rotates clockwise 291. The second Coaxial Actuator Discs 121 in this example connects with the second teetering hinge rotor 131 driven by the second rotary actuators 201. Hence, both discs 121, 122 together with both shafts 131,132 and actuators 201,202 may share a single rotation axis 195 and may share the same disc loading area 520.

In some embodiments of the presently disclosed subject matter, the Actuator Disc 120 is driven and powered by the Fluid Rotary Actuator 200. Since the Fluid Rotary Actuator 200 can adjust its maximum torque at any desired rotational speed 190 and at the same time to alternate its instant angular torque 210 in real-time. Hence, the Actuator Disc 120 may accommodate almost any suitable geometric rotor solidity ratio. Similar, the actuator disc 120 may be designed with rotor hub-to-blade ratio according to the application 800, since the Fluid Rotary Actuator 200 may provide any instant torque 210 at any desired instant rotational speed 295 and/or global rotational speed 190.

For example, according to the present disclosure, a moving platform 650 may in some cases be designed in a shape of an air-cushion vehicle (ACV), hovercraft and/or a vertical take-off vehicle, short take-off and landing vehicle. The moving platform 650 may have a thrust vectoring unit (FTVU) 100 comprised with Actuator Disc 120 as centrifugal blades providing the moving platform 650 with inflate pressure within its mainframe 615 and/or its inflated skirts. One or more additional attached vectoring unit (FTVU) 100 on the moving platform 650 may have an actuator Disc 120 with high rotor solidity>0.8 in order to provide an air cushioning mass flow and/or vertical take-off thrust vector 170 to the moving platform 650. Similarly, additional attached vectoring unit or units (FTVU) 100 may provide the moving platform 650 with Actuator Disc 120 with low rotor solidity ratio of say 0.1. This vectoring unit or units (FTVU) 100 with low rotor solidity ratio may provide the moving platform 650 with thrust surge and sway forces 170 of the moving platform 650.

Alternatively, in configurations of a moving platform 650 with only two or more tandem rotors configuration, one vectoring unit (FTVU) 100 may rotate clockwise with actuator disc 120 that has large area of disc loading 520 and rotor solidity ratio of say 0.1. While the second tandem vectoring unit (FTVU) 100 may rotate anticlockwise and has an actuator disc 120 with a smaller area of disc loading area 520 but with rotor solidity ratio of say larger than 0.6. This tandem rotor configuration may allow an odd number of tandem vectoring unit (FTVU) 100 to be attached on a single moving platform 650.

In some embodiments of the present disclosure, exemplified in FIG. 3 an actuator disc 120 is driven and powered by the Fluid Rotary Actuator 200. The fluid rotary actuator 200 has one or more inlet ports 250 and has one or more outlet ports 260 connecting to a network of pipes 330, part of the powertrain 300. The powertrain 300 may work in an open loop configuration when the working fluid 320 is a comprisable fluid such as gas, and/or air. Alternatively, in configurations of an open loop, the outlet port 260 of the rotary actuator 200 may be used as a gas exhaust, vent, throttle and/or any pressure or flow resistor.

In some embodiments, when the working fluid 320 is non-compressible fluid, such as oil, the powertrain 300 may work in a closed loop configuration. In a close loop configuration, the rotary actuator 200 outlet port 260 connects with the low pressure returned network of pipes 330, part of the powertrain 300.

In some cases, but not limited to current innovation, the fluid valving device 720 is an integral electro-mechanical element of the fluid rotary actuator 200 and/or of the powertrain 300, part of the piping network 330 and/or an integral element of the powerplant 400, part of the fluid pump mechanism 440. The electro-mechanical fluid valving device 720 may control, restrict, release, alternate and/or valve the working fluid 320,401,405, 409 entry to the inlet port 250 of the rotary actuator 200. Similarly, the fluid valving device 720 may act in the same manner on the working fluid 320,401,405, 409 exiting the outlet port 260.

In some embodiments, a combination of electro-mechanical fluid valving device 720 may be placed before the working fluid 320,401,405, 409 enters the rotary actuator 200 and/or may be placed after the working fluid 320,401,405, 409 leaves the rotary actuator 200, allowing the computer system 700 to manage and control by the software 780 the physical actions of the rotary actuator 200 such as breaking and/or instant changing direction of disc 200 rotation and/or allowing freewheeling. Moreover, the fluid valving device 720 controls and manages physically the amount of fluid 213, 212, 211 in molecular weight and/or volume 220 and/or pressure 230 and/or fluid entropy passing through the actuator 200, shown in FIG. 4 as area 213, area 212 and area 211 or an integral of 210 curves.

In some embodiments, a combination of one or more fluid powered thrust vectoring units (FTVU) 100 are attached on a single moving platform 650. In this example, each thrust vectoring units (FTVU) 100 may result in total Power Density of 0.3 kg/kW, where the thruster unit 100 weights between 0.05 kg up to 500 kg. This class of fluid powered thrust vectoring units (FTVU) 100 comprises a Fluid Rotary Actuator 200 operating on compressible fluid such an Air, part of the Trust Vectoring system (TVU)100. The air powered thrust vectoring units (FTVU) 100 can be used in volatile atmospheres, where electrical motors are neither allowed nor suitable. Similarly, an air powered thrust vectoring units (FTVU) 100 may provide the actuator disc 120 with a torque rating of about 1 N*m with vectoring units (FTVU) 100 below 1 kg, and up to 1 kN*m with thruster unit 100 weight above 1 kg.

Additionally, or alternatively, in some embodiments, a combination of one or more fluid powered thrust vectoring units (FTVU) 100 are attached on a single moving platform 650. Each thrust vectoring units (FTVU) 100 may result in total Power Density of 0.05 kg/kW where the thruster unit 100 weights between 1 kg up to 5,000 kg. This class of fluid powered thrust vectoring units (FTVU) 100 comprises a Fluid Rotary Actuator 200 that operates on non-compressible fluid 320 such as hydraulic oil. The hydraulic powered thrust vectoring units (FTVU) 100 may reach a power rate density of 1.5 MW/kg*s whereas a hydraulic power thruster unit 100 weights say 1000 kg can reach up to 1 MW/s power rate. For example, a moving platform 650 with one or more hydraulic powered thrusters (FTVU) 100 may have a total weight of less than 8 Tones, while the moving platform 650 may lift a payload of up to 30 Tones with disc loading area 520 of say 50 kg/m2 and below.

Additionally, or alternatively, the fluid thrust vectoring unit (FTVU) 100 introduced here has low polar moment of inertia 190 by tenfold when compared with existing engine Shaft cupelled/direct Thrust Vectoring System (STVS) 804 and/or Electrical Thrust Vectoring System (ETVS) 801 with similar mechanical energy, torque, angular motion and with identical total disc loading area. For example, a moving platform 650 may comprise number of thrust vectoring units (FTVU) 100 attached, and includes a powerplant 400 and a powertrain 300 and may have a total dry weight of say 100 kg. This moving platform 650 setup can generate up to 500 kgf with little to non-polar moment of inertia 190, as the rotating elements within the moving platform 650 are mainly the actuator disc 120, part of the thrust vectoring unit (FTVU) 100. This moving platform 650 may not comprise a rotating mass in a shape of a shaft nor rotating mass in the shape of an electrical coils and/or magnates. According to the present disclosure, a moving platform 650 with a low polar moment of inertia 190 may maneuver and accelerate without the resistance to angular displacement for forces such as gyro, centrifugal and internal torque/torsion.

In some embodiments of the present disclosure, the Fluid Rotary Actuator 200 is powered by the working fluid 320 which derived from the fluid powertrain 300 by a network of pipes 330. The working fluid 320 may be a compressible fluid such as an air gas for example. These types of working compressible fluids 320 may allow the Fluid Rotary Actuator 200, part of the Thrust Vectoring unit 100 to have a mechanical configuration of air motors such as rotary vane, axial piston, radial piston, gerotor, turbine, V-type, and diaphragm motors. Similarly, these mechanical configurations of air motors may be used as gas pump and/or a compressor 440 when a useful mechanical work 460 from the engine 430 drives these air pump 440. Hence, a gas pump and/or compressor 440, part of the powerplant 400, may feed the energized working fluid 401,409 with mass flow rate and pressure into the powertrain 300 network of pipes 330.

In some embodiments, the working fluid 320 of the Fluid Rotary Actuator 200 may be non-compressible fluid such as Hydraulic Oil. Thus, according to a broad aspect of the presently disclosed subject matter, the Fluid Rotary Actuator 200, part of the hydraulic powered thrust vectoring unit (FTVU) 100 may comprise hydraulic and/or Hydrostatics and/or non-compressible fluid motor configuration such as Gear Motors, Vane Motors, Piston Motors, Radial-Piston, Axial-Piston Motors, Angled axis motor, Low-speed hydraulic motors, Outside cam motors, Inside eccentric cam motors, Two-flow direction motor and/or Low-end orbital motors. In some cases, but not limited to current innovation this non-compressible fluid motor configuration may be used as a working fluid pump 440 which gets its useful mechanical work 450 from the attached engine and/or power unit 430 and/or from self-generated energized working fluid unit 670, 680, 690, a remote part of the moving platform 650.

According to the present disclosure, the pump 440 mechanical configuration and/or working principle of energized the working fluid 401 may include pump setup such as on-positive-displacement pump, centrifugal pump, axial pump, radial pump, positive-displacement pumps, reciprocating pumps, rotary pumps, gear pumps, external gear pumps, lobe pump, internal gear pumps, gerotor pumps, cam pump, screw pumps, vane pumps, piston pumps, axial piston pumps, radial piston pumps, reciprocating pumps.

According to some embodiments, as illustrated in FIG. 5A, a nozzle configuration 550 may be placed on the thrust vectoring units (FTVU) 100 outlet 160 providing additional control of the propulsive force 170 leaving the thrust vectoring units (FTVU) 100. In some embodiments, a nozzle configuration 550 of the thrust vectoring units (FTVU) 100 may change dynamically and in real-time the characteristics and/or the entropy of air mass 590 entering the nozzle mechanism 550. The nozzle 550 may transfer the fluid properties of the entered air mass flow 590 in temperature and/or pressure and/or mass and/or velocity and/or acceleration and/or fluid energy and/or the entropy of the air mass passing through. This transformation may take place by changing the nozzle exhaust area 553 and/or adding combustion process 577 and/or by adding propellant 420 and/or by changing the nozzle angle 551 with respect to the thrust vectoring units (FTVU) 100 geometry 101. These processes also known as nozzle control by Geometric area ratios, by Effective area ratios and/or by Differential area ratios.

Thus, according to the present disclosure, an additional degree of freedom is introduced to the propulsive force 170 in angle 179 and amplitude 175 while passing through the nozzle 550 configuration. The air mass flow 580 entering the thrust vectoring unit (FTVU) 100 may leave the vectoring unit (FTVU) outlet 160 as accelerated air mass flow 590. Additionally, or alternatively, part or some of the accelerated air mass flow 590 may leave the vectoring units (FTVU) 100 while part or some may enter into the nozzle mechanism 550,551,553 and then leave or exist or exhaust the vectoring unit (FTVU). Similar, part or some of the of the entered air mass flow 580 to the vectoring unit (FTVU) 100 may directly pass by the built-in channels 185 through the nozzle mechanism 550 and exist the vectoring units (FTVU) 100 as accelerated air mass flow 595 through the nozzle outlet 553.

Hence, the computer system 700 of the thrust vectoring units (FTVU) 100 and/or of the moving platform 650 may control the thrust vector 170 of the vectoring units (FTVU) 100 by actively managing the nozzle 550 features. In some cases, but not limited to current innovation nozzle mechanism 550,551,553 and methods may comprise of Axisymmetric, Converging-diverging nozzle (C-D), Converging nozzle, Effective Vectoring Angle nozzle, Fixed nozzle, Fluidic thrust vectoring nozzle, Geometric vectoring angle nozzle, Three-bearing swivel duct nozzle (3BSD), Three-dimensional (3-D) and Two-dimensional (2-D)vectoring nozzle, Thrust vectoring (TV) nozzle, Thrust-vectoring flight control (TVFC) nozzle, Two-dimensional converging-diverging (2-D C-D) nozzle

The moving platform 650 may have a fluid powertrain 300 that is physically connected using piping constellation 330 between the powerplant 400 and the thrust vectoring system (FTVU) 100. In some embodiments one or more thrust vectoring system 100 may connect to one or more powerplants 400 using long, flexible and lightweight pipe constellation 330,640. In other embodiments, the piping network 330,640 of the fluid powertrain 300 is rigid, part of the moving platform main frame 610 and/or of the powerplant mainframe 410 and/or of the thrust vectoring system (FTVU) 100 mainframe 110.

According to the present disclosure, the fluid powertrain 300 transfers the energized working fluid 401 generated by the powerplant 400 and/or by anther autorunning vectoring system (FTVU) 100 and/or by the stored fluid energy 325 to another thrust vertical system 100. Hence, the energized working fluid 401 may flow from the fluid powertrain 300 into the Fluid Rotary Actuator 200, part of the thrust vectoring system 100. The Fluid Rotary Actuator 200 converts the fluid energy 401 into kinetics energy as a useful mechanical work on the actuator disc 120. After doing work, the working fluid 409 leaves the Fluid Rotary Actuator 200 via the outlet port 220 and returns to the powertrain 300 via a network of pipes 330.

The term “fluid powertrain” 300 may include, but not limited to a fluid power device, fluid mechanics network of pipes 330, fluid connectors, fluids accessories such as hydrostatics transmission, pneumatics parts and/or hydraulic elements. According to the present disclosure, the fluid powertrain 300 may include one or more Accumulators 325 connected in parallel and/or serial, control valves 720, filters regulators, lubricators and/or silencers and/or fluid sensors and/or embedded fluid-electronic hardware. Similarly, the electro-mechanical valving control device 720, may have a powertrain 300 accessories and elements such as an electrohydraulic controls and solenoids providing the rotary actuator 200 with A Port, B Port, sink, pilot link, 705 com, 715 power electronic cables and 740 electrical power inputs and outputs.

Thus, according to the present disclosure, the powertrain 300 may comprise Fluid statics or hydrostatics hydraulics powertrain and/or pneumatics powertrain and other gases fluid dynamics, Pilot pipes, electrical attached mechanism on a fluid direct operation device which may include an energy storage, pressurized tank, drain out tank or sink, lubrication gear and cooling/heat recovery devices, heat pumps and/or refrigeration units and fluids. According to some embodiments, the working fluid 320 may act as a refrigeration fluid, where heat exchange ribs 370 are shown for example in FIG. 3. In other cases, a heat pump setup is included in the powertrain subsystem 300, allowing to use fluid energy 401 for cooling purposes.

In some embodiments of the present disclosure the fluid powertrain 300 is connected to one or more Fluid Rotary Actuators 200 and at the same time, the fluid powertrain 300 is also connected to one or more powerplants 400. The term “powerplant” may include, but not limited to an energy source 420 that feeds electrical energy 450 and/or fuel energy 450 to an engine/motor 430, as for example shown in FIG. 2. The engine/motor 430 is mechanically coupled 450 with a fluid pump/compressor 440. A powerplant 400 may have one or more of energy sources 420,470 such a batteries pack 470 and/or fuel tank 420. Similarly, powerplant 400 may have one or more of engines/motors 430 mechanically coupled with one or more pump/compressors 440. The powerplant 400 may have a structural frame 410 that is part of the moving platform 650. In some embodiments, the powerplant 400 has its own frame 410 which is not part of the moving platform mainframe 610.

In other configurations illustrated in FIG. 6B, the powerplant 400 and its frame 410 may have wheels, flywheels, tracked wheels, railroad wheels, flanged wheel, tracks and/or any other means of traveling on ground and/or creating friction with objects on the ground. In some configurations, 650, 670, 680, 690, the powerplant 400 may have means of drive on ground, creating ground to powerplant 400 friction and/or displacement in meters between the ground and powerplant 400 mainframe 410.

Similar configurations in other embodiments may allow the powerplant 400 to be part of a ship, a boat-shaped container, a boat and/or other means of moving powerplant 400 which is floated and/or propelled on water bodies, on water surfaces and under water surfaces and/or submerged within and between. Motion through water of the powerplant 400 may include other stages/phases of water such as liquid, snow and ice. In some embodiments of the present disclosure, the powerplant 400 is anchored on the ground and/or on a water body and/or anchored on ice and snow and/or anchored on a known moving platform.

In some embodiments of the present disclosure, as shown in FIG. 6B, the moving platform configuration 600 has a powerplant 400 configuration 680 that may have one or more thrust vectoring system 100 attached to its frame 410, this provides the powerplant 400 to jump, hover, move, taxi, fly, tilt, yaw, roll, pitch, and maneuver independently of the moving platform mainframe 610. In some other embodiments the powerplant mainframe 410 may maneuver in 6DOF independently of other thrust vectoring system (FTVU) 100 part of the moving platform 650. According to some embodiments, the powerplant frame 410 may maneuver in 6DOF independently while sharing and connecting 640 with other self-hovering thrust vectoring system (FTVU) 100 that may also share and connect by the same powertrain 300 network of piping 330 and cables. Additionally, or alternatively, in some embodiments, the powerplant 400 mainframe 410 may connect and share powertrain piping network 330 and other cabling 740,715,705 and communication means 799,795,791 illustrated in FIG. 6A as line 640.

In some embodiments of the present disclosure the engine/motor 430, part of the powerplant 400 consumes energy from the energy sources 420, 470 and converts this energy into useful work 460, resulting in kinetic energy on a shaft 450. The engine/motor 430 transfers this useful mechanical work 460 to the fluid pump/compressor 440, and in turn the fluid pump/compressor 440 is charging the entering working fluid 405 with fluid energy. For example, in some embodiments the working fluid 320 is an oil, and so the fluid pump 440 charges the entering working fluid 405 with hydraulic energy. Similarly, when the working fluid 320 is an air, the fluid pump 440 charges the entering working fluid 405 with a pneumatic energy. This working fluid 401 line enters the powertrain subsystem 300 and then into the Fluid Rotary Actuator 200, part of the thrust vectoring unit (FTVU) 100.

In some cases, a powerplant 400 may comprise number of pumps 440, each linked directly with the rotary actuator 200 by a piping constellation 330. In some embodiments, a combination of fluid pump may be used, one for example as a heat pump 440 cupelled with shaft to the engine 430 releasing heat accumulated by the working fluid 320 using the radiator 320, where the other pumps 440 on the same powerplant 400 may be used to energize the working fluid 320 for the purpose of propelling one or more actuators 200 with an energized working fluid 401.

In some embodiments, a combination of one or more fluid powered thrust vectoring units (FTVU) 100 attached on a single moving platform 650 create a total Disc Loading Configuration 500 of the moving platform 650. Each thrust vectoring unit (FTVU) 100 may result in well-defined Disc loading size 520 in meter squared.

According to some embodiments, the thrust vectoring units (FTVU) 100 may have Disc Loading Configuration 500 where the payload 615 of the moving platform 650 acts as the mainframe 610 of the moving platform 650. Once the moving platform 650 has completed its mission of transferring the payload 615, the moving platform may continue its mission without its payload 615 in a modular manner. In some embodiments, the modular moving platform 650 may detach from its mainframes 110,410,610 while landing, lifting, carrying, hovering and/or during a mission. This detached mode of the moving platform while hovering and maneuvering in the air may allow the powertrain 300 elements such as piping 330 and/or parts of the computer system 700 such as communication 705, power-electronics 715 and/or electrical grid 740 cables to be connected between the detached and modular parts of the moving platform 650. According to this example, the assembled configuration of the modular moving platform 650 while lifting and hovering with a payload of say 30 Tones may have a disc loading 500 configurations with power density of above 6 kg/kW and with a disc loading of 50 kg/m2. According to this example, and in the case of detached modular moving platform 650 without the payload 615, the moving platform 650 may have a higher hovering efficiency of say less of a 3 kg/kW with less of 20 kg/m2 disc loading.

According to some embodiments, the moving platform 650 without payload 615 may reach a high hover vertical lift efficiency with flexible Disc Loading 520 area reaching a 0.1 kg/m2 of gross weight to disc loading area of the moving platform 650. Additionally, or alternatively, a combination of one or more fluid powered thrust vectoring units (FTVU) 100 may be used as a human powered helicopter. According to this example, the human powered moving platform may have a human as the powerplant 400 with up to 7-4 W/kg power generation creating a vertical lift efficiency of say 512 kg/kW and 0.1 kg/m2 of disc loading.

Similar, an efficient maneuvering platform 650 powered by a fueled engine 430 with total gross weight of say 200 kg, may have one or more thrust vectoring units (FTVU) 100. According to this example, the fueled powered moving platform may provide the moving platform 650 with only 1 kg/kW while keeping less than 15 kg/m2 disc loading, assume powerplant 400 reaches a max of 0.5 kg/kW includes fuel tank.

In some embodiments of the present disclosure, the Actuator Disc 120 and the Fluid Rotary Actuator 200, part of the fluid thrust vectoring unit (FTVU) 100 have an internal computer system 700 on board and/or attached and/or wired/embedded. The Realtime clock 707 may have an interrupt handler function 777 or the timer interrupt handler 777 in this case to perform the above-mentioned periodic duties on the electro-mechanical valving 720 in a PWM manner 711 with electrical power variation 713 and/or servo control 719 positioning with power variation 717. In some cases, the signals 711,719 that drive the electrical mechanical valving device 720 are represented as digital signals 711 and/or analogue signals 719 which control and manage the working fluid entering 730 passing 320 and/or leaving 735 the valving device 720. In some cases, the signals 711,719 may act together and at the same time on the valving device 720 synchronized by the timeline 777. In other embodiments the signals 711,719 may act independently and/or may alternate between the two signals 711 and 719 synchronized by the timeline 777.

In some embodiment, illustrated in FIG. 2 and FIG. 3, the power-electronics pulses (Volts/Amps) and/or signals 711,719 and/or electrical average power in (Watts) 711,719 are transferred to and from the fluid valving device 720 by the power electronics and control connections 715. Once the signals 711,719 have arrived to the fluid valving device 720, the device translates the Direct Current (DC) and/or Alternated (AC) and/or electrical instant power (W) and/or the instant electrical energy (W/sec) 711,719 and/or any Pulse-width modulation (PWM), or pulse-duration modulation (PDM) of electrical signals 711,719 into a mechanical movement that acts as a valving mechanism on the fluid enters 730 and leaving 735 the valving device 720.

For example, as shown in FIG. 4, a valving device 720 part of the actuator 200 body may comprise one or more solenoids and/or servo motors and/or combination of the two. The computer system 700 may send a power electronics signals 711 and/or 711 from the power electronics board 710 to the valving device 720. As a result, the electromechanical valving device 720 may provide the rotary actuator 200 with instant torque 210 and/or fluid power 213,212 and 211 which acts on the actuator 200 internal mechanism to provide a useful work on the actuator disc 120. Hence, the instant torque 210 controls and manages the actuator 200 angular motion and position 290,295,299. This method of control may occur repeatedly and in a synchronized manner by the line time 777.

In some embodiments of the present disclosure each moving platform has one or more thrust vectoring unit (FTVU) 100. Each thrust vectoring unit (FTVU) 100 may have an independent computer system 700 embedded within and/or one or more real-time thruster controller units 700 with a clock 707 and a real-time software 780 per single moving platform 650. In other embodiments there is a single computer system 700 that connects to number of power electronics boards 710, each attached to and managing a single thrust vectoring unit (FTVU) 100 in real-time, part of a single platform 650. Similarly, each thrust vectoring unit (FTVU) 100 may have only one or more power electronics board 710 attached/connected to a remote computer system 700 and/or remote server cloud 791.

The computer system 700 may include the power electronic controller board 710 and may include the fluid valving device 720, each of the controller 710 and the device 720 may be part of the computer and control system 700 and/or connected to the computer system 700 by means of digital and analogue transmission and receiving of electrical voltage/power and/or electromagnetics signals and/or optical signals. The connections between the internal elements of the computer 700 system 780,710,720 may be done via wireless RF and/or wireless free optics and/or by cable means such as fiber optics and/or metallic wires.

In some embodiments of the present disclosure a moving platform 650 may include one or more fluid thrust vectoring unit (FTVU) 100 and an additional one or more Electrical vectoring thrust system (ETVS) 801 powered by an electrical grid 740. The electrical grid 740 is part of the computer system 700 and managed by the thruster control system software 780. The power electronics controller 710, part of the computer unit 700 may power, manage and control the attached fluid thrust vectoring unit (FTVU) 100 and/or the thrust system (ETVS) 801 attached to the moving platform 650.

In some embodiments of the present disclosure a moving platform 650 may include one or more fluid thrust vectoring unit 100 and an additional one or more Electrical vectoring thrust system (ETVS) 801. In some cases, and during the moving platform 650 mission 800, the Electrical vectoring thrust system (ETVS) 801 may autorun and self-generate an electrical power by the forced air mass flow 580 entering the electrical vector thrust system (ETVS) 801. The electrical power generated by the thrust system (ETVS) 801 is damped into the electrical grid 740 and may be stored on a battery unit 470 part of the powerplant 400.

In other cases, one or more computer units/systems 700 may generate electrical power using the fluid generator, where the self-generated electrical power may be used by the power electronics board 710. As shown for example in FIG. 3 the fluid electrical generator 745 is attached to the actuator 200. This electrical generator 745 may be part of the power plant 400 and/or in-line on the fluid powertrain 300 and/or part of the fluid power thrust vectoring unit (FTVU) 100.

Additionally, or alternatively, the mechanical electrical power generator 745 may be attached to the fluid thrust vectoring unit (FTVU) 100 mainframe 110 and self-generate its electrical power/energy in Joules, Watts and/or kWh. The mechanical generator 745 may generate its power from the mechanical motion of the fluid rotary actuator 200 and/or from the energized working fluid 401 and/or from the air mass flow 580,585,590,595 passing through the thrust vectoring unit (FTVU) 100.

Thus, according to the present disclosure, the computer system 700 is comprised from thruster controller software 780, power electronics system 710 and a fluid valving device 720. Hence, the computer system 700 is also connected to set of sensors as follows: the sensors 760 and 765 are measuring the valving device 720 performances and/or the working fluid 320 entering and leaving the valving device 720. Similar, the sensors 771,775 and 779 are sensing and measuring the thrust vectoring unit (FTVU) 100 performances by providing information calculated and compute the thrust vector 170 size 175 and angle 179 using air mass physical datum 580,585,590,595 and/or by measuring working fluid 320 total entropy enters and leaves the actuator 200 and/or by measuring the motion of the thrust vectoring unit (FTVU) 100.

Alternatively, as in configurations illustrated schematically in FIG. 3, the sensor set 781,785 and 789 may measure the motion and position for navigation purposes of the thrust vectoring unit (FTVU) 100 and/or may measure the 6DOF information for applications purposes 800. Additionally, or alternatively, the remote sensor 799 may provide the moving platform 650 and/or the application 800 and/or the thrust vectoring unit (FTVU) 100 with measurable information of a remote location and/or the space around the thrust vectoring unit (FTVU) 100 and/or measurable information of the air mass around and/or far from the thrust vectoring unit (FTVU) 100.

The real-time software 780 and the computer hardware 700 may comprise different layers of software and hardware attached to the moving platform 650 and/or the fluid thrust vectoring unit (FTVU) 100. The software 780 may operate in a closed loop algorithm and/or open loop algorithm under a fast-real-time clock (RTC) 707. Hence, the real-time clock 707, part of the computer system 700 provides the instant torque 210 generated by the rotary actuator 200 with a time keeping 777 with high sampling rate, higher by 10 k samples per second, while the rotational speed 190 of the actuator 200 is below say 10 k RPM. In some cases, the computer hardware 700 attached to the actuator 200 may tick and clock 707 at a rate of 100 kHz reaching up to 10'0 of GHz using means of time keeping such as temperature-controlled crystals, optical and/or radioactive oscillators.

Thus, according to the present disclosure, the computer software 780 (programming and algorithm) is part of the computer system 700 and may receive physical data from the moving platform 650 and/or fluid thrust vectoring unit (FTVU) 100 by the attached sensors and/or remote sensors 799 using remote communication means 795 and/or internal and external communication and power electronics cables 705 and 715. This may include Radio Frequency (RF) communication between parts, elements and layers of the computer system 700 of the moving platform 650 and/or thrust vectoring unit (FTVU) 100.

In some embodiments of the present disclosure the computer system 700 may operate in a cloud computing manner 791, and allow on-demand availability of computer power, storage and resources with computer functionally connected to distributed sensors 760,765,771,775,779,781,785,789 and/or distributed of power electronics board 710, and/or distributed fluid valving devices 720 and/or distributed remote components such as 791,795,799 over multiple locations, each location being a data center, server, embedded hardware and/or self-managed computer units 700 in all sizes, types and shapes. This distributed cloud computing network 700 may provide one or more moving platforms 650 and/or one or more fluid power thrust vectoring unit (FTVU) 100 to operate and act in real-time and in a flock configuration while undertaking flock mission 800 over time, space, and unique geometrical configuration. For example, the computer system 700 on the moving platform 650 may act and manage one or more fluid vectoring thrust units 100 in a cloud distributed manner 791 using remote information from 799,795,791. Similarly, number of moving platforms 650 may undertake a flock mission 800 where each computer system 700 on each moving platform communicates 795 and acts with any thrust vectoring unit (FTVU) 100, a part of the moving platforms 650 flock.

In some embodiments, as illustrated in FIG. 6B, one or more pumps/compressors 440 are connected 441,442,443 to an engine/motor 430. In some cases, but not limited to current innovation the pumps/compressors 440 may comprise a variable displacement pump 440 controlled by a valving device 720 and/or controlled directly by the computer 700 power electronics board 710. Each pump 441,442,443 may communicate with the electronics board 720 using signals 711,719 and fluid information in a similar manner to the valving device 720 methods of operations. In some cases, the servo-solenoid controlled mechanism within the pump 440 mechanical setup may comprise a swashplate and/or internal electro-mechanical actuator which is controlled by signals 719, 711 and by doing so may manage the working fluid 320 entering the pump 440 and the working fluids leaving the pump 440.

Referring again to the non-limiting embodiment illustrated in FIG. 6A, one or more pumps 441,442,443 may be connected with network of fluid pipes 330 and other cabling 740,715,705 and communication means 799,795,791 as illustrated in FIG. 6A by line 640 to one or more rotary actuators 200 in a direct manner and/or in a parallel manner and/or in serial manner. Hence, each pump 441,442,443 may power one or more thrust vectoring unit (FTVU) 100 and/or any combination of moving platforms 650 and/or any platform configurations 600. For example, the computer system 700 may generate by its real-time software 780 number of controlled signals 719,711 and/or the computer system 700 may generate a different signal 711,719, where there is a signal for each pump 441,442,443 in an independent manner. These signals 719,711 may change the pump 440 swashplate angle and/or the displacement volume and/or pressure while useful mechanical work 460 is done on the pump 440 by the engine/ motor 430. This allows each pump 441,442,443 to be connected independently to a rotary actuator 200 and/or to an array of actuators 200. This platform configuration 600 may power each thrust vectoring unit (FTVU) 100 only by displacement changes of each pump 440 by the computer system 700 real-time software 780.

Referring again to the non-limiting embodiment illustrated in FIG. 6B, in some platform configurations 670,680,690, the energized working fluid 320 may be generated by internal pump 440 and/or unknown generation methods 680 of energized working fluid 320, part of a remote platform configuration 670,680,690. In some cases, the platform configuration 690 may provide only useful mechanical work 460 to one or more moving platforms 650 and/or to one or more thrust vectoring units (FTVU) 100 by activating one or more pumps 440.

In other cases, as referring to FIG. 6B, the platform configuration 680 may comprise an unknown powerplant 400 and a powertrain 640 connected to one or more rotary actuators 200 attached with wings 630 and/or control surfaces 620 and/or managing attached robotics application 800.

The term “platform application” 800 may include, but not limited to any physical useful work on an object 820 and/or any physical interaction with the object 820. The object 820 may be in a form of mass and/or may have a force and/or may have a momentum and/or may have a center of gravity, second moment of area and/or moment of inertia. In some applications 800, the object 820 may be a mass with black body radiation and/or an object 820 that emits radiation and/or an object 820 that absorbs radiation. Additionally, or alternatively, the thrust vectoring unit (FTVU) 100 is attached directly with the object 820 in other cases the thrust vectoring unit (FTVU) 100 is remote to the object 820.

In some embodiments of the presently disclosed subject matter, the platform configuration 100, 650, 670,680,690 and 600 may comprise the payload 615 and/or an application payload 820 and/or power tool 815 and robotic apparatus 815. Each platform configuration 100, 650, 670,680,690,600 and/or any combination between these platform configurations may provide a particular application 800 which powered by one or more thrust vectoring unit (FTVU) 100.

In some cases, the application 800 may provide torque and/or polar friction between 815 and 820, in other cases the application 800 may provide friction and/or any type of force and/or momentum between 815 and 820. Additionally, or alternatively, the application 800 may provide communication means and/or vision means between 815 and 820. The application 800 may provide a thermodynamics environment between 815 and 820, by changing temperature, fluid entropy and/or volume and pressure between 815 and 820. Hence, the platform configuration may keep stabilization and/or other methods of control systems in order to accomplish the interaction between 815 and 820 and/or between 650 and 615.

In some embodiments of the present disclosure, the sensory and devices of the platform configuration 100, 600, 650, 670, 680 ,690 may comprise optical sensors, camera system, image sensors, vision machine and/or remote sensing sensors which includes fast and parallel computer hardware 700 such as FPGA, GPU, ARM and/or embedded hardware. The application 800 may comprise a robotic arm, cargo loading as a payload and/or passenger transport.

1. A thrusting assembly configured for mounting on an aerial platform for generating thrusting power, the thrusting assembly comprising:
one or more fluid-based rotary actuators in fluid communication with a source of energized working fluid for receiving energized working fluid to thereby driving the one or more fluid-based rotary actuators;
one or more actuator disc arrangements, each of said one or more actuator disc arrangements comprising a plurality of blades rotatable by kinetic energy delivered by said one or more fluid-based rotary actuators; each of the one or more actuator disc arrangements being coupled to a respective one of said one or more fluid-based rotary actuators by a rotatable shaft, such that rotation of said one or more actuator disc arrangements provides air mass flow through the one or more actuator disc arrangements and causes acceleration of air mass flow in and out the thrusting assembly and maneuver of the aerial platform;
a valving mechanism is disposed along a flow path between the source of energized working fluid and the one or more fluid-based rotary actuators;
an angular position sensor configured for sensing the angular position of the rotatable shaft and generate angular position data based thereon;
at least one processing circuitry; one or more memories coupled to the at least one processing circuitry and storing programming instructions for execution by the at least one processing circuitry to control said valving mechanism to provide a selected rotation profile of said one or more actuator disc arrangements, based on the angular position data of the rotatable shaft, said selected rotational profile of said one or more actuator disc arrangements comprising a varying angular acceleration in a single disc revolution or in a selected number of disc revolutions while maintaining a selected revolution per minute (RPM) in said single disc revolution or in said selected number of disc revolutions, enabling angular acceleration of the blade in part of the single disc revolution or of the selected number of disc revolutions of the blades, or angular deceleration of the blade in part of the single disc revolution or of the selected number of disc revolutions according to a given and desired angular velocity.

2. The thrusting assembly of claim 1, wherein the plurality of blades are coupled to a respective rotor by a hinge, wherein the angle of attack of the plurality of blades is defined by the forces acting on the hinge.

3. The thrusting assembly of claim 1, wherein the processing circuitry is configured to control said valving mechanism to result in at least one of: (i) a selected mass flow rate of said energized working fluid towards the one or more fluid-based rotary actuators, (ii) selected fluid pressure, and (iii) selected temperature of said energized working fluid in said one or more fluid-based rotary actuators or being received in said one or more fluid-based rotary actuators.

4. The thrusting assembly of claim 1, characterized by at least one of the following:
said processing circuitry is configured to control said source of energized working fluid, directly or indirectly, to affect the fluid pressure being output therefrom;
said processing circuitry is configured to control the angular velocity of said blades and the angle of attack of each blade;
said processing circuitry is configured to control said valving mechanism by a pulse-width modulation technique or electro-mechanical fluid technique;
said processing circuitry is configured to control the valving mechanism to allow a controlled maneuvering of the aerial platform in at least six degrees of freedom;
said processing circuitry is configured to control said valving mechanism to control the angular position, velocity and acceleration of the one or more fluid-based rotary actuators, or at least the rotatable shaft by the one or more fluid-based rotary actuators, to thereby control mechanical-motion of the one or more actuator disc arrangements.

5. The thrusting assembly of claim 1, wherein said energized working fluid is liquid and said one or more fluid-based rotary actuators are hydraulic motors.

6. The thrusting assembly of claim 5, wherein said liquid flows in a closed-loop system.

7. The thrusting assembly of claim 1, wherein said energized working fluid is gas and said one or more fluid-based rotary actuators are gas motors.

8. The thrusting assembly of claim 7, wherein said gas is air and said one or more fluid-based rotary actuators operate based on an open-loop flow of said gas.

9. The thrusting assembly of claim 1, characterized by at least one of the following: said rotatable shaft is a rotor shaft coupled to said one or more fluid-based rotary actuators for allowing rotation of the respective fluid-based rotary actuator; an said rotatable shaft is a motor shaft coupled to the respective actuator disc arrangement of said one or more actuator disc arrangements for allowing rotation of the respective rotor.

10. The thrusting assembly of claim 1, wherein said processing circuitry is configured to control the angular position, velocity and acceleration of said blades and the angle of attack of each blade, the processing circuitry being configured to control the angle of attack of each blade independently.

11. (canceled)

12. The thrusting assembly of claim 1, comprising a tilt sensor for sensing the tilt of the aerial platform and generate tilt data based thereon, wherein said processing circuitry is configured to control said valving mechanism based on said tilt data.

13. (canceled)

14. (canceled)

15. The thrusting assembly of claim 1, comprising the source of energized fluid being characterized by at least one of the following:
said source of energized fluid comprises one or more sub-sources of energized working fluid, each being configured to provide an energized working fluid in a different pressure and mass flow rate to allow feed of the one or more fluid-based rotary actuators with a range of pressures of the fluid;
said source of energized working fluid comprises one or more liquid pumps;
said source of energized working fluid comprises one or more compressors.

16. (canceled)

17. (canceled)

18. The thrusting assembly of claim 1, comprising a cooling arrangement in fluid communication with said source of energized working fluid for cooling the energized working fluid.

19. The thrusting assembly of claim 1, comprising a power source for powering said source of energized working fluid.

20. (canceled)

21. (canceled)

22. The thrusting assembly of claim 1, wherein said one or more fluid-based rotary actuators are operable to result in air mass flow through the thrusting assembly in two opposite directions.

23. The thrusting assembly of claim 22, wherein said processing circuitry is configured to control said valving mechanism to controllably result said air mass flow through the thrusting assembly in two opposite directions.

24. The thrusting assembly of claim 1, comprising a combustion component configured to heat air mass flow that flows from the one or more actuator disc arrangements to thereby further accelerating the air mass flow.

25. The thrusting assembly of claim 24, wherein said combustion component comprises a nozzle, wherein the air mass flow is heated to thereby accelerate within said nozzle.

26. The thrusting assembly of claim 1, wherein said aerial platform is an autonomous aerial platform.

27. The thrusting assembly of claim 1, characterized by at least one of the following:
propulsive force of the thrusting assembly comprises a disc loading profile controlled by at least one characterization of said one or more actuator disc arrangements: an instant torque, instant angular torque, alternate instant angular torque, instant rotational speed, global rotational speed, or any combination thereof:
the thrusting assembly is configured to generate autorotation energy in response to autorotation of the one or more fluid-based rotary actuators;
said one or more actuator disc arrangements comprise one or more tandem actuator disc arrangements, each has a pair of coaxial actuator disc arrangements members.

28. The thrusting assembly of claim 1, wherein the thrusting assembly is configured to generate autorotation energy in response to autorotation of the one or more fluid-based rotary actuators, said autorotation energy being either directly used to drive said one or more fluid-based rotary actuators or stored in an energy storage of the thrusting assembly.

29. (canceled)

30. The thrusting assembly of claim 1, wherein said one or more actuator disc arrangements comprise one or more tandem actuator disc arrangements, each having a pair of coaxial actuator disc arrangements members, said one or more actuator disc arrangements being characterized by at least one of the following: comprising and odd number of said one or more tandem actuator disc arrangements; and each member of the pair of coaxial actuator disc arrangements is configured to rotate in an opposite direction to the other member.

31. (canceled)

32. (canceled)

33. (canceled)

34. An aerial platform, comprising:
the thrusting assembly of claim 1;
platform mission and application utility configured to operate a desired operation while the aerial platform is airborne.

35. The aerial platform of claim 34, wherein the platform mission and application utility is driven by the energized working fluid supplied from the source of energized working fluid.

36. A thrusting assembly configured for mounting on an aerial platform for generating thrusting power, the thrusting assembly comprising:
one or more fluid-based rotary actuators in fluid communication with a source of energized working fluid for receiving energized working fluid to thereby driving the one or more fluid-based rotary actuators;
one or more actuator disc arrangements, each comprising a plurality of blades, rotatable by said one or more fluid-based rotary actuators;
a valving mechanism is disposed along a flow path between the source of energized working fluid and the one or more fluid-based rotary actuators;
a combustion component configured to heat air mass flow that flows from the one or more actuator disc arrangements to thereby further accelerate the air mass flow;
at least one processing circuitry; one or more memories coupled to the at least one processing circuitry and storing programming instructions for execution by the at least one processing circuitry to control said valving mechanism to result in at least one of: (i) selected fluid mass flow rate, (ii) selected fluid pressure, and (iii) selected temperature of said energized working fluid in said one or more fluid-based rotary actuators or being received in said one or more fluid-based rotary actuators.

37. A thrusting assembly configured for mounting on an aerial platform for generating thrusting power, the thrusting assembly comprising:
one or more fluid-based rotary actuators in fluid communication with a source of energized working fluid for receiving energized working fluid to thereby driving the one or more fluid-based rotary actuators; and one or more actuator disc arrangements, each comprising a plurality of blades, rotatable by said one or more fluid-based rotary actuators; the thrusting assembly thereby generating autorotation energy in response to autorotation of the one or more fluid-based rotary actuators;
a valving mechanism is disposed along a flow path between the source of energized working fluid and the one or more fluid-based rotary actuators; and
at least one processing circuitry; one or more memories coupled to the at least one processing circuitry and storing programming instructions for execution by the at least one processing circuitry to control said valving mechanism to result in at least one of: (i) selected fluid mass flow rate, (ii) selected fluid pressure, and (iii) selected temperature of said energized working fluid in said one or more fluid-based rotary actuators or being received in said one or more fluid-based rotary actuators.
